(19) United States
(12) Patent Application Publication
(10) Pub. No.: US 2024/0157516 A1
(43) Pub. Date: May 16, 2024

(54) METHOD OF ASSEMBLING A PLIERS ACTUATION ASSEMBLY GROUP, PLIERS ACTUATION ASSEMBLY GROUP AND PLIERS

(71) Applicant: WEZAG GmbH & Co. KG, Stadtallendorf (DE)

(72) Inventor: Gunthard Gebhard, Amöneburg (DE)

(21) Appl. No.: 18/389,244

(22) Filed: Nov. 14, 2023

(30) Foreign Application Priority Data
Nov. 15, 2022 (EP) 22 207 537.6

(51) Int. Cl. B25B 7/06; B25B 7/14

(52) U.S. Cl. CPC B25B 7/06; B25B 7/14

(57) ABSTRACT

The invention relates to a pliers actuation assembly (1), pliers and a method of assembling a pliers actuation assembly (1). According to the invention, a locking pawl (85) has protrusions (89), a spring (86) has protrusions (92) and/or pulling bars (16, 17) have protrusions (14, 15) which are received in accommodations (90, 93, 12, 13) of hand lever plates (64, 65, 66, 67) in a joining direction vertical to the pivoting plane of hand levers (2, 3). The inventive design facilitates assembly of the pliers actuation assembly (1), while also enabling an at least partially automated assembly.

### CROSS REFERENCE TO RELATED APPLICATIONS

This application claims priority to co-pending European Patent Application No. EP 22 207 537.6 filed Nov. 15, 2022.

### FIELD OF THE INVENTION

The invention relates to a pair of pliers that can be held and guided by a user's hand and is manually operated by application of forces by a user to hand levers of the pliers.

For the design of the pliers there are the following variants:
a) It is possible that the pliers are crimping pliers, which are used in particular to provide a permanent mechanical connection and an electrical contact. This is preferably done by crimping a plug to a cable or an electrical conductor of any type. Depending on the profile of the dies to be used, different crimping processes can be carried out with the crimping pliers or the crimping machine. For example, it may be a closed crimp in which the conductor is inserted into a closed crimp zone of a plug or into a closed sleeve and crimped by plastic deformation of the crimp zone or sleeve. However, it is also possible that an open crimp is created in which the plug has an open crimp zone into which the conductor can be inserted from above. To give just a few examples which do not limit the invention, the crimping pliers relevant here can be used to crimp workpieces such as
   cable lugs or shoes according to DIN 4623,
   aluminum connectors according to DIN 46329,
   aluminum compression cable lugs or shoes according to DIN 48201,
   squeezed cable shoes or terminals according to DIN 46234,
   pin cable lugs or shoes according to DIN 46230 or
   connectors, plugs or cable lugs or shoes for a connection to a cable or conductor as described in the WEZAG GmbH Werkzeugfabrik product catalog “Werkzeuge für die professionelle Anwendung” with the publication no. 10/11.
   The crimp produced can be, for example, a closed crimp, a hexagonal crimp, a square crimp, a B-crimp, a trapezoidal crimp, a modified trapezoidal crimp, an oval crimp, a mandrel crimp or a double mandrel crimp. An open crimp can e. g. be a V-crimp or B-crimp, a rolled crimp or a double rolled crimp.
   In addition to establishing the electrical connection between cable or conductor and connector, a mechanical connection can be established by means of a so-called insulation crimp. Here, a closed insulation crimp or an open insulation crimp (in particular V-crimp or B-crimp, O-crimp or OV-crimp) can be used. Regarding further information
      for the design of a crimping tool,
      to possible applications of the crimping pliers and/or
      to different possible types of crimp connections, which can be made by means of the crimping tool,
   reference is made to the publication
      “Crimptechnik, Herstellung prozesssicherer Verbindungen von elektrischen Leitern und Steckern” of WEZAG GmbH Werkzeugfabrik, Die Bibliothek der Technik 342, Publisher Moderne Industrie, ISBN 978-3-68236-027-7.
   Crimping pliers in various designs are known, for example, from the publications DE 37 08 727 C2, DE 197 13 580 C2, DE 197 53 436 C2, DE 198 02 287 C1, DE 198 07 737 C2, EP 3 208 044 A1 and EP 2 305 428 A1.
b) It is also possible that the pliers are tube pressing pliers that are used to produce a mechanical fluid-tight connection in fluid technology, for example to connect pipes to each other or to fluidic connection plugs. In this case, the tube pressing pliers provide a plastic deformation of the pipes to be connected or of a so-called fitting ensuring the mechanical connection and the fluid-tight seal. Exemplary embodiments of tube pressing pliers can be found in the publications DE 197 09 639 A1, DE 198 34 859 C2, DE 199 24 086 C2, DE 199 24 087 C2, DE 199 63 097 C1, DE 103 46 241 B3, EP 2 995 424 A1.

The invention also relates to a pliers actuation assembly group which can be coupled to a pliers head to form a pliers in such a way that a stroke of die halves of the pliers head can be brought about by means of a manual actuation of the pliers actuation assembly group.

Furthermore, the invention relates to a method by means of which a pliers actuation assembly group can be assembled.

### BACKGROUND OF THE INVENTION

DE 100 56 900 C1 discloses a crimping tool comprising a crimping pliers actuation assembly group and a crimping tool head. The crimping pliers actuation assembly group has two hand levers that are pivotally connected to each other via a pivot bolt. A pulling bar is hinged to each of the hand levers at a distance from the pivot bolt. The crimping pliers actuation assembly group has a forced locking mechanism, by means of which a partially closed position of the hand levers, once reached during a crimping stroke, is secured in a ratchet-like manner and an opening movement of the hand levers is only made possible at the end of the crimping stroke. The crimping pliers head has a pliers head frame to which a fixed die half is fixed and on which a movable die half is guided for displacement in the direction of a crimping axis. The movable die half is supported by a spring device on the die head frame in such a way that the spring device biases the die half in an opening direction. The pliers head frame has frame plates extending parallel to one another, between which the fixed die half is held and the movable die half is guided. For assembling the crimping pliers actuation assembly group to the crimping pliers head, the movable die half has a U-shaped pivot bolt accommodation which is open on one side in the direction of the pivot bolt of the crimping pliers actuation assembly group. Furthermore, the pliers head frame has pulling bar coupling devices that have through bores of the frame plates oriented vertically to the pliers head plane. The pulling bars each have a through bore oriented vertically to the pliers head plane in the end region facing away from the linkage to the hand levers. For assembly, the crimping pliers actuation assembly group is approached to the crimping pliers head in such a way that the pivot bolt, which pivotally couples the hand levers to each other, enters the pivot bolt accommodation. At the same time, the pulling bars are pivoted between the frame plates so that the bores in the frame plates are aligned with the bores in the pulling bars. Coupling bolts or rivets are then inserted into the aligned bores. In the assembled state, the crimping pliers head with the frame plates and the pulling bars arranged therein is trapped between heads of the coupling bolts and a latching ball of the coupling bolt. Remote from the pivot bolt, via which the two hand levers are connected to each other so that they can be pivoted, a transverse bolt is held on one hand lever and extends into an elongated hole in the other hand lever—This elongated hole is curved in such a way that the elongated hole extends concentrically to the pivot axis provided by the pivot bolt. A maximum opening angle of the hand lever is defined by the fact that the transverse bolt comes to rest on an end limitation of the elongated hole. The crimping pliers have a forced locking mechanism. The forced locking mechanism secures a partially closed position of the hand levers against an opening movement, even if the hand forces applied by the user to the hand levers are temporarily reduced or eliminated, which also secures the contact of the die halves with a workpiece and prevents an undesired relative movement of the workpiece in the die halves. The forced locking mechanism ensures that an opening movement of the hand levers and thus of the die halves is only possible when the hand levers reach a closed position. The forced locking mechanism has a locking pawl that is rotatably mounted on the hand levers. The locking pawl is biased by a spring, which is linked at a spring base to an associated hand lever. Here, the spring is designed as a spiral tension spring with open wire eyes at the ends that can be hooked into bores in the hand lever and the locking pawl, the bores being oriented vertically to the pivoting plane of the hand levers.

Crimping pliers which are assembled in a corresponding way are known from EP 2 463 969 A2.

EP 3 834 989 A1 discloses a hand pliers tool which can be embodied as crimping pliers, tube pressing pliers or cutting pliers. In order to reduce the number of components of the hand pliers tool and to simplify the assembly and disassembly EP 3 834 989 A1 proposes that a pliers pivoting part (which can be embodied as a pliers jaw part, a locking pawl or a pressure lever) comprises a plate-shaped base body. The base body is accommodated and guided between two side plates of hand lever or a fixed pliers jaw part. A pivot bolt is formed integrally by the base body of the pliers pivoting part. The pivot bolt comprises aligned pins arranged on both sides of the base plate. The pivot bolt is accommodated in an accommodation formed in one of the side plates for providing a pivot bearing. In order to allow the assembly of the pliers pivoting part to the hand lever providing the side plates or to the fixed pliers part the hand lever or the fixed pliers part forms a bearing lug for one pin embodied as a bore having a closed edge and on the other hand a bearing lug for the other pin being accessible via an insertion slit. During the assembly it is possible to insert one pin into the bearing lug having the closed edge whereas then the pliers pivoting part is pivoted via the insertion slit into the bearing lug having the open edge.

Further prior art is known from EP 0 303 889 A2.

### SUMMARY OF THE INVENTION

The invention proposes a method for assembling a pliers actuation assembly group.

This pliers actuation assembly group can be coupled to a pliers head to form pliers in such a way that a stroke of die halves of the pliers head can be brought about by means of manual actuation of the pliers actuation assembly group.

The inventive pliers actuation assembly group is in particular improved in terms of
the number of components of the pliers actuation assembly group and/or
the assembly and/or disassembly and/or
the enabling of at least partially automatic assembly.

The invention also proposes a correspondingly improved pliers actuation assembly group as well as correspondingly improved pliers.

For one embodiment the pliers actuation assembly group to be assembled has two hand levers. At least one of the hand levers has two hand lever plates that are rigidly connected to each other (for fully assembled pliers actuation assembly group). The two hand levers are pivotally connected to each other via a pivot bolt.

The pliers actuation assembly group to be assembled can have a forced locking mechanism which secures a partially closed position of the hand levers with respect to an opening movement and only allows an opening movement when a closed position of the hand levers has been reached. The forced locking mechanism can then have a locking pawl that is pivotably mounted on a hand lever. The locking pawl can be biased by a spring. A spring base of the spring can be supported on the hand lever on which the locking pawl is mounted. In this respect, the pliers actuation assembly group to be assembled can also be designed, for example, according to the prior art DE 100 56 900 C1 mentioned at the beginning.

In the pliers actuation assembly group to be assembled a mounting element, namely
the locking pawl of any forced locking mechanism,
the spring of any forced locking mechanism and/or
at least one pulling bar by means of which the pliers actuation assembly group can be coupled to the pliers head,

has shoulders and protrusions arranged in front of the shoulders.

The shoulders and protrusions can advantageously be used as follows: Assembly can by carried out by joining the locking pawl, the spring and/or the pulling bar in a joining direction into a hand lever plate. In this case, the joining direction is oriented in particular vertically to the main extensional plane of the hand lever plate. The joining direction denotes a direction relative to this main extensional plane of the hand lever plate. With this joining, a protrusion of the locking pawl, the spring and/or the pulling bar enters into an accommodation of the hand lever plate. In this case, the accommodation is an accommodation passing through the hand lever plate or a blind hole-like accommodation. The cross-section of the accommodation can be closed- or open-edged. Preferably, the accommodation is a through bore of the hand lever plate. At the end of the said joining movement and of the entry of the protrusion into the accommodation, a shoulder of the locking pawl, spring or pulling bar adjacent to the protrusion comes into contact with the hand lever plate in the joining direction. In this way, already an axial fixing or a stop for the position of the locking pawl, spring and/or pulling bar is provided in the joining direction. The cross sections of the protrusion on the one hand and of the accommodation on the other hand can be selected in such a way that the protrusion can be rotated in the holder, which then ensures a relative pivoting movement of the locking pawl, spring and/or pulling bar with respect to the hand lever plate. It is also possible that the accommodation of a protrusion in an accommodation forms a spring base for supporting the spring.

After the aforementioned joining step, the other hand lever plate is joined in the same joining direction (relative to the first hand lever plate), which results in the hand lever plate being joined to the locking pawl, spring and/or pulling bar. During this joining movement, the other protrusion of the locking pawl, spring and/or pulling bar enters an accommodation of the other hand lever plate. To the design of the accommodation the above applies accordingly. At the end of this joining movement, one shoulder of the locking pawl, the spring and/or the pulling bar comes into contact with the other hand lever plate.

In a subsequent assembly step, the relative position of the hand lever plates is fixed, which can be done by screwing the hand lever plates to each other, riveting the hand lever plates to each other or by providing any other firm connection of the hand lever plates to each other. In the fixed state of the relative position of the hand lever plates, the shoulders of the locking pawl, spring and/or pulling bar are then trapped between the two hand lever plates. In this way, the locking pawl, spring and/or pulling bar are/is secured against disassembly from the hand lever plates that are fixed relative to each other.

In the case that the spring has the protrusions and the shoulders, the assembly as proposed represents a significant simplification of the assembly process for the connection of the spring base of the spring, since a filigree threading of an eyelet of the spring into the hand lever plate, which requires high manual skill, is unnecessary. Instead, the spring can simply be joined axially in the area of the protrusion in the aforementioned joining direction.

A simplified assembly also results for the design of the locking pawl and/or the pulling bar with the protrusions and the shoulders, in which (to put it simply) it is only necessary to insert the protrusions into the associated accommodations. Nevertheless, a very reliable and robust connection is ensured which, if necessary, also guarantees the required pivoting degree of freedom of the locking pawl and/or the pulling bar relative to the hand lever plates.

It is certainly possible for the spring, the locking pawl and/or the pulling bar to be formed in several parts, in which case they can have, for example, a base body which can have a recess or bore into which pins or bolts can be inserted to form the protrusion, and in which the shoulders can be formed in the transition region from the pins or bolts to the base body. However, for one proposal the locking pawl and/or the pulling bar are formed integrally (also monolithically) with the protrusions and shoulders, whereby on the one hand additional assembly steps can be avoided and on the other hand the number of components can be reduced.

It is possible that the assembly and/or joining is done manually, in which case this manual assembly is simplified as explained. For a further proposal, an at least partially automated assembly takes place. Under certain circumstances, only the explained joining of the locking pawl, the spring and the pulling bar in the explained joining direction into one hand lever plate and the subsequent joining of the other hand lever plate in the same joining direction enables an automated assembly, in which the locking pawl, the spring or pulling bar is gripped via a handling means moved by an actuator and is then inserted in the joining direction into the hand lever plate. Following this, the same handling element or another handling element actuated by the same or a different actuator can then join the other hand lever plate. For example, the first-mentioned hand lever plate can rest on an assembly table and the locking pawl, spring and/or pulling bar can then be inserted vertically from above in the joining direction with subsequent assembly of the other hand lever plate, also from above. An at least partially automated assembly was not possible for pliers actuation assemblies known from the prior art (or only with an unjustifiable effort). For example, according to the prior art, automatic hooking of spring eyes of a spring into bores of the locking pawl and/or the hand lever plate, which are oriented vertically to the pivoting plane of the hand levers, can at best be performed with a great deal of automation.

A further solution to the object of the invention is provided by a pliers actuation assembly group having the design features as previously described. Preferably, such a pliers actuation assembly group has been assembled by the method previously explained.

In principle, the locking pawl can be manufactured in any way (even in a one-piece design with the shoulders and the protrusion). For example, the locking pawl may be manufactured as a casting, a milled part, or a MIM part. For one proposal, the locking pawl is a bent sheet metal part. In this case, the sheet metal part forms in particular the shoulders and the protrusions, an engagement part and an actuating part. The engagement part engages a toothing of the forced locking unit. The actuating part, on the other hand, serves as an actuating surface for the spring. It is possible that the spring engages in the actuating part, for example engages in a recess of the engagement part that has a closed or open edge. Alternatively, it is possible that the spring merely rests loosely against the locking pawl in the area of the actuating part in order bias the locking pawl.

There are also many different possibilities for the design of the spring. For one proposal, the spring is a T-shaped metal sheet spring. In this case, the vertical leg of the T can form a leaf spring, while the two horizontal legs of the T form the protrusions. The transitions from the vertical leg to the horizontal legs of the T then form the shoulders. The length of the vertical leg can be greater than the length of the horizontal legs of the T by a factor of at least 5, at least 10 or at least 15, for example. A spring formed in this way represents a particularly simple and cost-effective design of the spring, which at the same time enables simple assembly, reduces the variety of components and/or is robust against a change in the spring characteristic, even in continuous operation.

For another embodiment, the spring is a leg spring, coil or spiral spring or circular spring, preferably made from a spring wire. In this case, the spring has two legs. One leg has an angled section at the end which is oriented parallel to the bending axis of the leg spring and forms a protrusion which (after insertion in the joining direction) is received in an accommodation of a hand lever plate. The other leg, on the other hand, biases the locking pawl, which can be the case by the other leg simply resting on the locking pawl or by the leg engaging in the locking pawl.

For the design of the spring as a leg spring, coil or spiral spring or circular spring with two legs, it is possible that the other leg also has an angled section at the end. Preferably, the two angled sections of the two legs are oriented parallel to each other, but in opposite directions. The end sided angled section of the other leg then forms a protrusion that engages in an accommodation of the locking pawl.

In another embodiment of the pliers actuation assembly group, the locking pawl has two positions, namely a securing position and a release position. In the securing position, the locking pawl can slide ratchet-like along a toothing of the forced locking mechanism during a closing movement of the hand levers, while the locking pawl blocks an opening movement of the hand levers for the purpose of ensuring the function of the forced locking mechanism. In the release position, on the other hand, the locking pawl slides ratchet-like along the teeth of the forced locking mechanism during an opening movement of the hand lever. In a known embodiment, for example according to DE 100 569 00 C1, the locking pawl is biased by a tension spring, the loading of which is at a maximum in the securing position. When the hand levers reach the closed position, the tension spring pulls the locking pawl into the release position, which minimizes the bias of the spring. In a modified embodiment the locking pawl is coupled to the spring in such a way that the bias of the spring is at a minimum in a position between the securing position and the release position. This means that, starting from the position in which the loading of the spring is minimum, the bias of the spring increases (to the same extent or to different extents) in the direction of the securing position and in the direction of the release position. Compared to the prior art, in this way a different force level of the spring can given on the one hand in the locking position and on the other hand in the release position, which can be advantageous for the function of the pliers actuation assembly group. On the other hand, according to the prior art, the spring and its spring stiffness and strength must be selected in such a way that the spring force can be varied from the minimum to the maximum for the entire pivoting angle between the locking position and the release position. Instead, the change in the spring force between the minimum position and the securing position, on the one hand, and the minimum position and the release position, on the other hand, only has to be ensured for a reduced angular range between the minimum and the maximum rising when approaching the securing position or the release position. Preferably, the spring is coupled to the locking pawl in such a way that (starting from the position in which the spring force is minimum) the spring is biased in the same direction both when moving towards the locking position and towards the release position.

Suggested is also a pair of pliers which, on the one hand, has a pliers actuation assembly group as explained above. Furthermore, the pliers have a pliers head which can be coupled to the pliers actuation assembly group in such a way that a stroke of die halves of the pliers head can be brought about by means of a manual actuation of the pliers actuation assembly group. Here, the coupling between the pliers actuation assembly group and the pliers head can basically be accomplished according to the embodiments disclosed at the beginning, in particular embodiments according to DE 100 56 900 C1, or in another manner described in the present application text.

Advantageous further embodiments of the invention result from the patent claims, the description and the drawings.

The advantages of features and of combinations of several features mentioned in the description are merely exemplary and can be affected alternatively or cumulatively, without the advantages necessarily having to be achieved by embodiments according to the invention.

With regard to the disclosure—not the scope of protection—of the original application documents and the patent, the following applies: Further features can be taken from the drawings—in particular the geometries shown and the relative dimensions of several components to each other as well as their relative arrangement and effective connection. The combination of features of different embodiments of the invention or of features of different patent claims is also possible in deviation from the selected referrals of the patent claims and is hereby suggested. This also applies to such features which are shown in separate drawings or are mentioned in the description thereof. These features can also be combined with features of different patent claims. Likewise, features listed in the patent claims may be omitted for further embodiments of the invention, which does not apply to the independent patent claims of the granted patent.

The features mentioned in the patent claims and the description are to be understood with respect to their number in such a way that exactly this number or a larger number than the number mentioned is present, without requiring an explicit use of the adverb “at least”. Thus, for example, when one element is mentioned, this is to be understood as meaning that exactly one element, two elements or more elements are present. The features listed in the patent claims may be supplemented by further features or may be the only features that the subject matter of the respective patent claim has.

The reference signs contained in the patent claims do not represent a limitation of the scope of protected by the patent claims. They merely serve the purpose of making the patent claims easier to understand.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows an exploded view of a pliers actuation assembly group of a pair of pliers.

FIG. 2 shows a three-dimensional representation of the pliers actuation assembly group of a pair of pliers according to FIG. 1 in an assembled state.

FIG. 3 shows an exploded view of a pliers head of a pair of pliers that can be used together with a pliers actuation assembly group according to FIGS. 1 and 2.

FIG. 4 shows a three-dimensional representation of the pliers head of a pair of pliers according to FIG. 3 in an assembled state.

FIGS. 5 to 8 show in three-dimensional representations an assembly and operation of pliers with a pliers actuation assembly group according to FIGS. 1 and 2 and a pliers head according to FIGS. 3 and 4.

FIG. 9 shows a partially assembled state of pliers according to FIGS. 5 to 8 in a top view on the pliers head plane.

FIG. 10 shows a sectional view of the pliers according to FIGS. 5 to 9 cut parallel to the pliers head plane.

FIG. 11 shows the pliers according to FIGS. 5 to 10 in a closed position in a top view on the pliers head plane.

FIG. 12 shows the pliers according to FIGS. 5 to 11 in the closed position in sectional view cut parallel to the pliers head plane.

FIG. 13 shows a three-dimensional representation of a pulling bar as it can be used in a pliers actuation assembly group according to FIGS. 1 and 2 and pliers according to FIGS. 5 to 12.

FIG. 14 shows an exploded view of another embodiment of a pliers actuation assembly group.

FIG. 15 shows a three-dimensional representation of the assembled pliers actuation assembly group of FIG. 14.

FIG. 16 shows an exploded view of a pliers head that can be used together with a pliers actuation assembly group according to FIGS. 14 and 15.

FIG. 17 shows the pliers head according to FIG. 16 in assembled condition in a three-dimensional representation.

FIGS. 18 to 21 show pliers, which have a pliers actuation assembly group according to FIGS. 14 and 15 and a pliers head according to FIGS. 16 and 17, in different assembly and operating states in a top view on the pliers head plane, partially in a cut state with sectional guidance parallel to the pliers head plane.

FIGS. 22 and 23 in three-dimensional representations show different possible configurations of pulling bars of a pliers actuation assembly group according to FIGS. 14 and 15 and of pliers according to FIGS. 18 to 21.

FIG. 24 shows a three-dimensional exploded view of a pliers actuation assembly group.

FIG. 25 shows a three-dimensional representation of a stop part of a pliers actuation assembly group of FIG. 24.

FIG. 26 shows a three-dimensional representation of a pivot bolt of a pliers actuation assembly group of FIG. 24.

FIGS. 27 to 37 show different mounting states for an assembly of a pliers actuation assembly group of FIG. 24.

FIG. 38 shows a three-dimensional representation of a locking pawl of a forced locking mechanism which consists of a metal sheet and integrally forms protrusions and shoulders.

FIG. 39 shows a three-dimensional representation of a T-shaped leaf spring of a forced locking mechanism.

FIGS. 40 to 42 show a top view of a partially assembled or partially cut pliers actuation assembly group having a forced locking mechanism with a locking pawl as shown in FIG. 38 and a spring as shown in FIG. 39, where FIG. 40 shows the spring and locking pawl in an intermediate position in which the bias of the spring is minimal, while FIG. 41 shows the locking pawl and the spring in a securing position, and FIG. 42 shows the locking pawl and leaf spring in a release position.

FIG. 43 shows a three-dimensional representation of a locking pawl which integrally forms the protrusions and shoulders.

FIG. 44 shows a spring designed as a torsion leg spring with two legs.

FIGS. 45 to 47 show a top view of a partially assembled or partially cut pliers actuation assembly group having a forced locking mechanism with a locking pawl as shown in FIG. 43 and a spring as shown in FIG. 44, where FIG. 45 shows the locking pawl and the spring in an intermediate position, while FIG. 46 shows the locking pawl and the spring in a securing position, and FIG. 47 shows the locking pawl and the spring in a release position.

FIG. 48 shows a top view of a partially assembled or partially cut design of a pliers actuation assembly group with an alternative design and arrangement of a spring embodied as a torsion leg spring with two legs.

FIG. 49 shows a three-dimensional representation of a locking pawl.

FIG. 50 shows a three-dimensional view of a spring embodied as a circular spring from a spring wire with two angled sections at the ends.

FIG. 51 shows a top view of a partially assembled or partially cut pliers actuation assembly group with a forced locking mechanism with a locking pawl according to FIG. 49 and a spring according to FIG. 50.

### DETAILED DESCRIPTION

In the following description, components or features which correspond to each other or are similar in terms of design, geometry and/or function are partially labelled with the same reference numbers, in which case they may be distinguished from one another by means of a supplementary letter a, b, . . . . In this case, the components or features can be referred to with or without the supplementary letter, whereby without using the supplementary letter then one component or feature, several components or features or all components or features can be addressed.

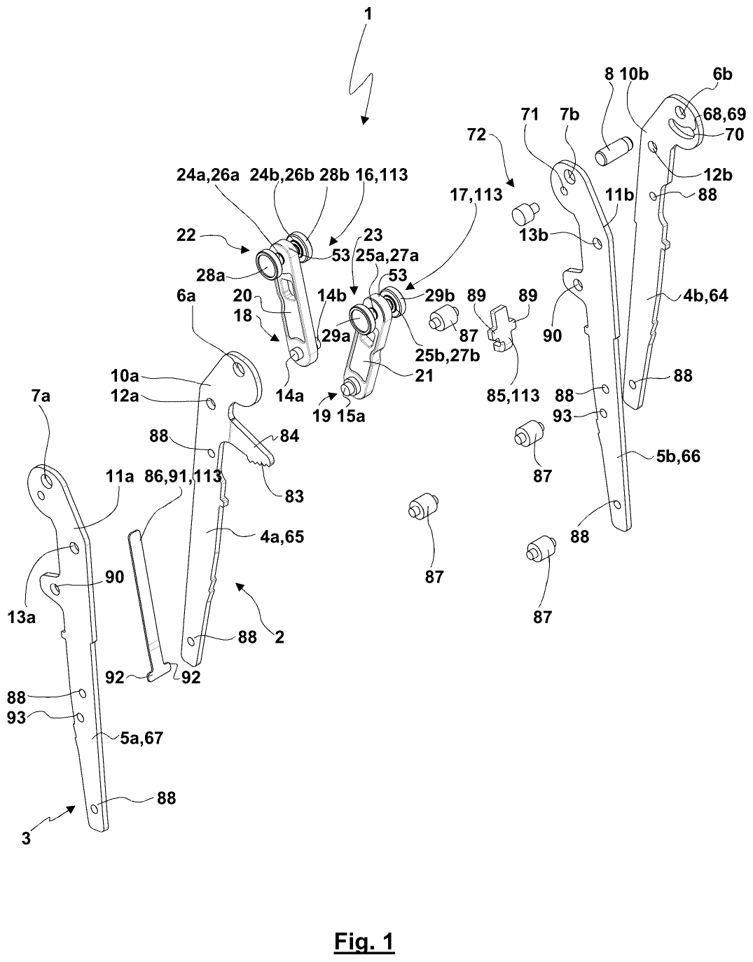

FIG. 1 shows a pliers actuation assembly group 1. The pliers actuation assembly group 1 has hand levers 2, 3. The hand lever 2 is formed with two hand lever plates 4a, 4b. Correspondingly, the hand lever 3 is formed with two hand lever plates 5a, 5b.

In the end region facing away from the grip part of the hand levers 2, 3, the hand levers 2, 3 each have a bearing eye 6, 7, which are formed here as bearing eyes 6a, 6b of the hand lever plates 4a, 4b and as bearing eyes 7a, 7b of the hand lever plates 5a, 5b.

The bearing eyes 6, 7 are bores through which a pivot bolt 8 extends. In this way a pivot bearing 9 is formed. By the pivot bearing 9, the hand levers 2, 3 are pivotably connected to each other so that they can perform an opening and closing movement for causing a (crimping or pressing) stroke and an opening stroke.

The hand levers 2, 3 are preferably slightly angled relative to one another with angular sections 10, 11. In the region of the angled sections 10, 11, the hand levers 2, 3 have accommodations 12, 13, here embodied as bores. In these accommodations 12, 13, protrusions 14, 15 of pulling bars 16, 17 forming pivot bolts are accommodated. In this way pivot bearings 18, 19 are formed, by which the pulling bars 16, 17 linked for being pivoted to the hand levers 2, 3. For the illustrated embodiment, the pulling bars 16, 17 each have protrusions 14a, 14b and protrusions 15a, 15b on both sides of a base body 20, 21, respectively, which are received in accommodations 12a, 12b and accommodations 13a, 13b of the hand lever plates 4a, 4b and 5a, 5b, respectively.

The pulling bars 16, 17 are rectilinear and of strut or rod-like design. In the end regions facing away from the protrusions 14, 15, the pulling bars 16, 17 each have a coupling element 22, 23. On both sides of their base bodies 20, 21, the coupling elements 22, 23 have coupling element parts 24a, 24b and 25a, 25b, respectively, which are designed here as coupling pins 26a, 26b and 27a, 27b, respectively, and have extensions 28a, 28b, 29a, 29b in the end regions facing away from the base body 20, 21.

For the embodiment shown in FIG. 1, the pulling bars 16, 17 are integrally formed or monolithic so that the base bodies 20, 21, the protrusions 14, 15 and the coupling elements 22, 23 are integral parts of a single structural component.

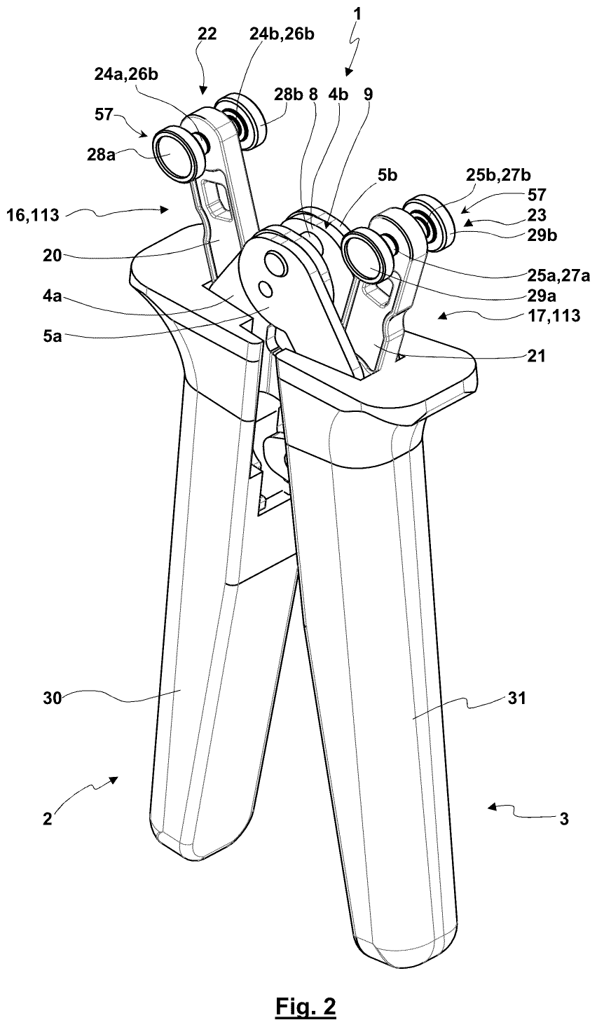

FIG. 2 shows the pliers actuation assembly group 1 in the assembled state. Here, elastomeric handles 30, 31 are additionally pushed onto the hand levers 2, 3. It can be seen here that the pulling bars 16, 17 with the coupling elements 22, 33 protrude freely upwards from the pliers actuation assembly group 1. The pulling bars 16, 17 can be pivoted freely as a result of the linkage via the pivot bearings 18, 19 to the hand levers 2, 3. Furthermore, the pivot bolt 8 is freely accessible from above between the hand lever plates 4, 5.

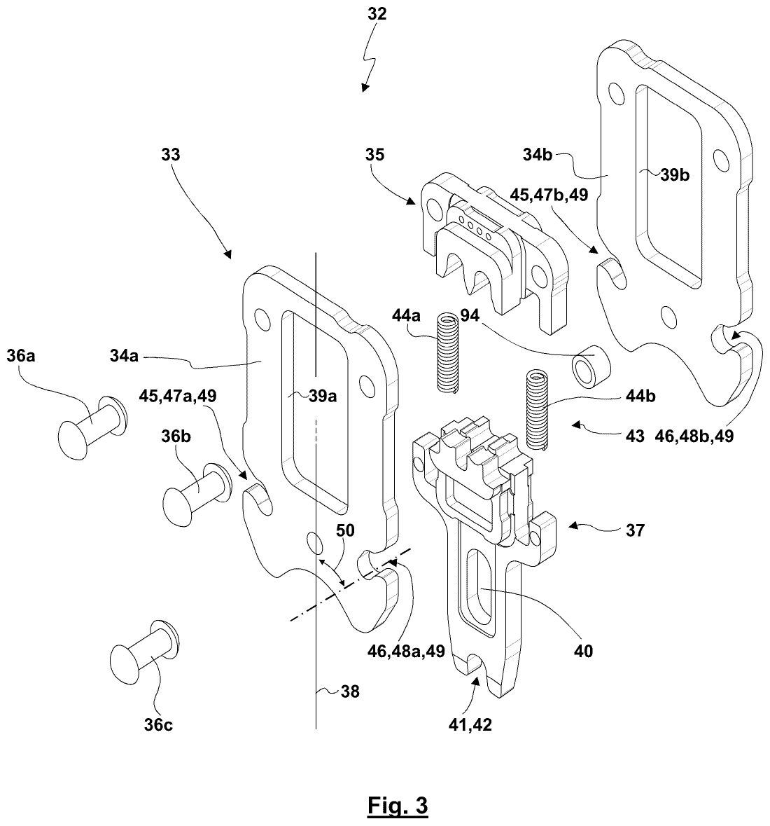

FIG. 3 shows a three-dimensional exploded view of a pliers head 32. The pliers head 32 has a pliers head frame 33, which here comprises frame plates 34a, 34b. A fixed die half 35 is arranged between the frame plates 34a, 34b. Connecting elements, in particular rivets 36a, 36b, connect the frame plates 34a, 34b and the fixed die half 35 arranged between them to form a fixed structural unit. The two frame plates 34a, 34b are further connected by a further rivet 36c.

The plier head 32 further has a movable die half 37. The movable die half is guided for being displaced on the plier head frame 33 in the direction of a crimping or pressing axis 38, which can be done, for example, by the frame plates 34a, 34b having recesses 39a, 39b that form lateral guide surfaces on which guide surfaces of the movable die half 37 are guided. The rivet 36c can extend with the sleeve 94 through a recess 40 of the movable die half 37 and provide additional guidance and/or a limitation of the movement of the movable die half 37.

In the end region facing away from the fixed die half 35, the movable die half 37 has a pivot bolt accommodation 41. In the embodiment shown, the pivot bolt accommodation 41 is designed as a U-shaped recess 42, which has an open-edged cross section. The pivot bolt accommodation 41, in this case the recess 42, is open downwards, i.e. in the state mounted on the pliers actuation assembly group 1 in the direction of the pliers actuation assembly group 1.

The pliers head 32 comprises a spring device 43, which is formed here with two springs 44a, 44b. The springs 44 are designed as compression springs. One spring base of the springs 44 is supported on the pliers head frame 33 and/or the fixed die half 35, while the other spring base of the springs 44 is supported on the movable die half 37. In the open position, in which the die half 37 has the maximum distance from the die half 35, the bias of the spring device 43 is minimal, while the bias of the spring device 43 increases as the die half 34 approaches the die half 35 over the crimping or pressing stroke. For the illustrated embodiment, the springs 44 are symmetrically arranged on both sides adjacent die surfaces of the die halves 35, 37 between which the workpiece is crimped or pressed.

The pliers head frame 33 has coupling recesses 45, 46. Here, the frame plates 34a, 34b form coupling recess parts 47a, 47b of the coupling recess 45 and coupling recess parts 48a, 48b of the coupling recess 46.

For the embodiment shown, the coupling recesses 45, 46 and the coupling recess parts 47, 48 are formed as elongated holes 49 open on one side in the outer end region. In this case, the elongated holes 49 are inclined at an acute angle 50 with respect to the crimping or pressing axis 38, the angle 50 preferably being in the range of 20-80° or 30 to 60° or 35 to 55°. Here, the acute angle 50 is oriented such that the apex points towards the pliers actuation assembly group 1, so that an entry movement from the outside into the elongated hole 49 has a component oriented towards the pivot bolt accommodation 41 and the pliers actuation assembly group 1. The elongated hole 49 may have non-parallel lateral boundaries that have any curvilinear shape when projected onto the pliers head plane.

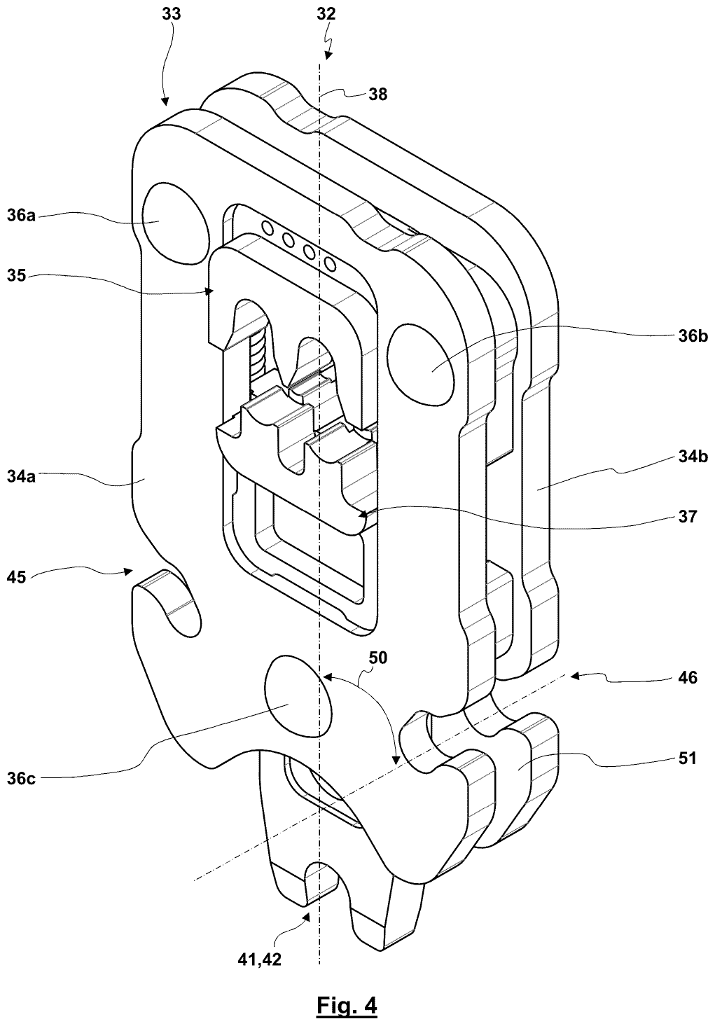

As a result of the distance between the frame plates 34, there is a gap 51 between the frame plates 34 (cf. FIG. 4). This gap 51 also exists between the pairs of coupling recess parts 47a, 47b and coupling recess parts 48a, 48b. In the area of the rivets 36a, 36b, the gap 51 between the frame plates 34 is defined by the die half 35. Instead, the rivet 36c is surrounded by a sleeve 94, which defines the distance between the frame plates 34 in the area of the rivet 36c.

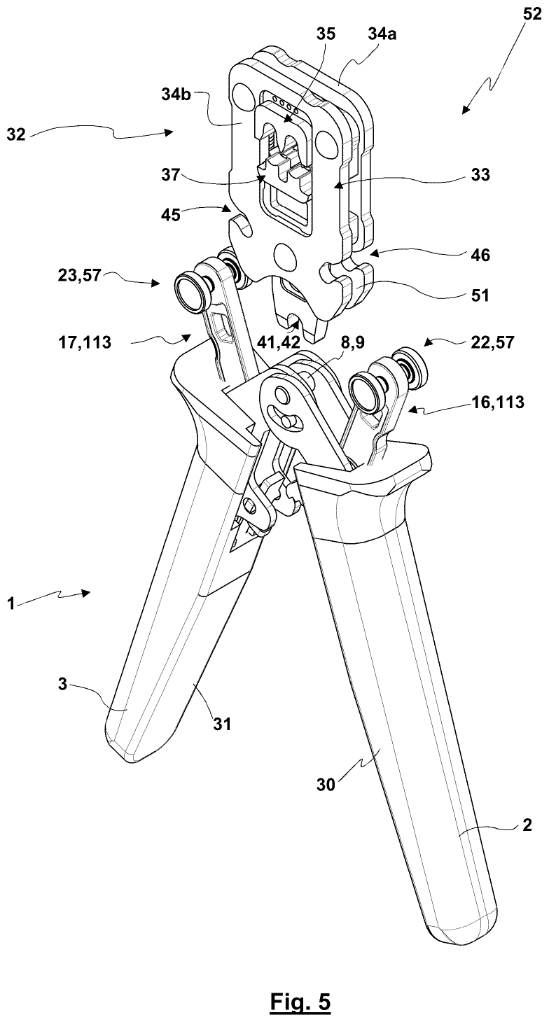

FIG. 5 shows the pliers actuation assembly group 1 and the pliers head 32 before assembly.

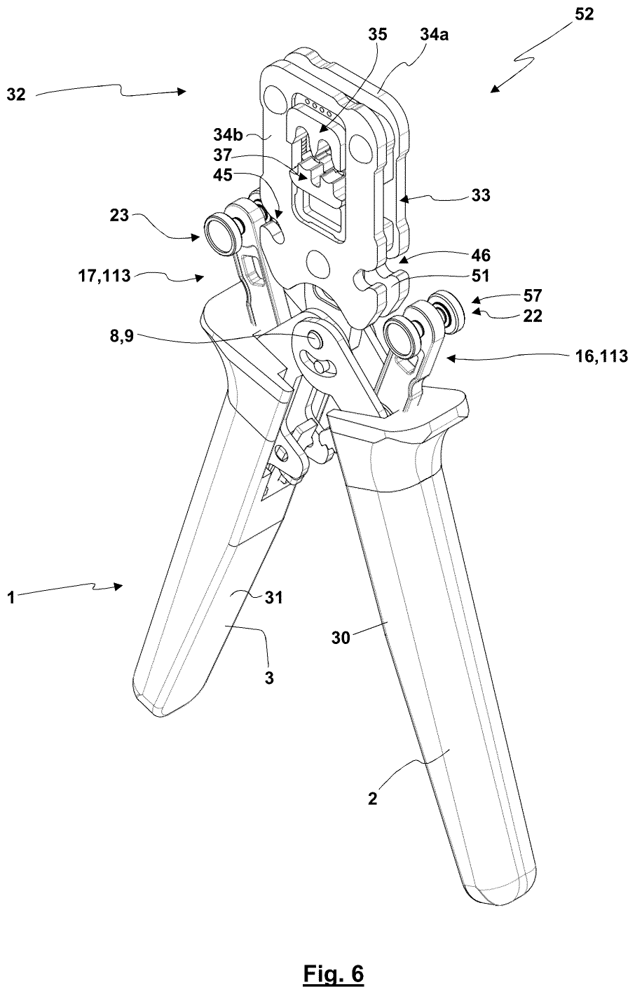

Referring to FIG. 6, for assembly, the pliers actuation assembly group 1 is approached to the pliers head 32 from below such that the pivot bolt 8 enters the pivot bolt accommodation 41 from below. By bringing the pivot bolt 8 into contact with the bottom of the pivot bolt accommodation 41, an actuating force can be transferred between the pliers actuation assembly group 1 and the pliers head 32, which strives to push the movable die half 37 upward. However, in the partially assembled state shown in FIG. 6, the pulling bars 16,17 are still in a pivoted position in which they are laterally of the pliers head frame 33 without being coupled.

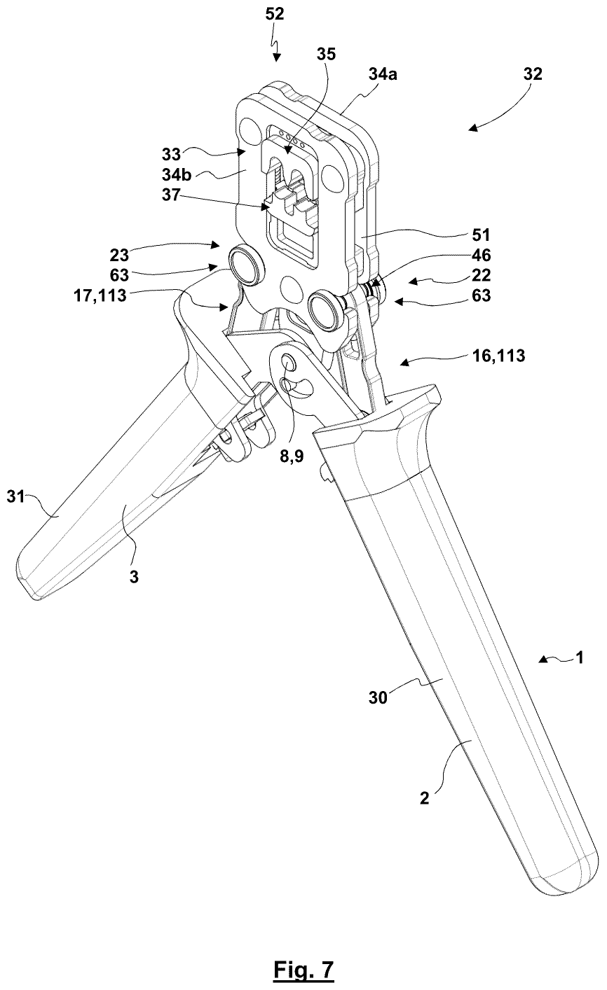

For further assembly, as shown in FIG. 7, the pulling bars 16, 17 are pivoted inward towards each other and towards the pliers head frame 33 until the coupling elements 22, 23 of the pulling bars 16, 17 enter the coupling recesses 45, 46 of the pliers head frame 33. In the present case, the coupling pins 26a, 26b enter the coupling recess parts 47a, 47b of the frame plates 34a, 34b and the coupling pins 27a, 27b of the pulling bar 17 enter the coupling recess parts 48a, 48b of the pliers head frame 33. At the same time, the base bodies 20, 21 of the pulling bars 16, 17 enter the intermediate space 51 formed between the frame plates 34a, 34b.

The length of the pulling bars 16, 17 is dimensioned such that the explained entry of the coupling elements 22, 23 into the coupling recesses 45, 46 can only occur when a movement of the movable die half 37 in the closing direction occurs. This movement is greatest when the coupling elements 22, 23 enter straight into the openings of the coupling recesses 45, 46, while a return movement of the movable die half 37 in the opening direction can occur when the coupling elements 22, 23 move into the interior of the coupling recesses 45, 46 to the bottom thereof. The partial closing movement required for the entry of the coupling elements 22, 23 into the coupling recesses 45, 46 is smaller than the crimping or pressing stroke and is, for example, less than 20%, less than 15% or less than 10% of the crimping or pressing stroke. At the end of the entry movement, when the coupling elements 22, 23 rest against the bottom of the coupling recesses 45, 46, the movable die half 37 can again reach the initial position, i.e. the maximum open position. Preferably, however, a partial closing stroke then remains, which may be, for example, less than 10% or less than 5% of the crimping or pressing stroke. The explained partial closing movement and the described partial closing positions are accompanied by a loading of the spring device 43. The spring force of the spring device 43 causes the coupling elements 22, 23 to be drawn into the coupling recesses 45, 46 and to be pressed with a spring force component against the bottom of the coupling recess 45, 46. Disassembly with the coupling elements 22, 23 being moved out of the coupling recesses 45, 46 thus requires overcoming this spring force component, which is generated by the spring device 43.

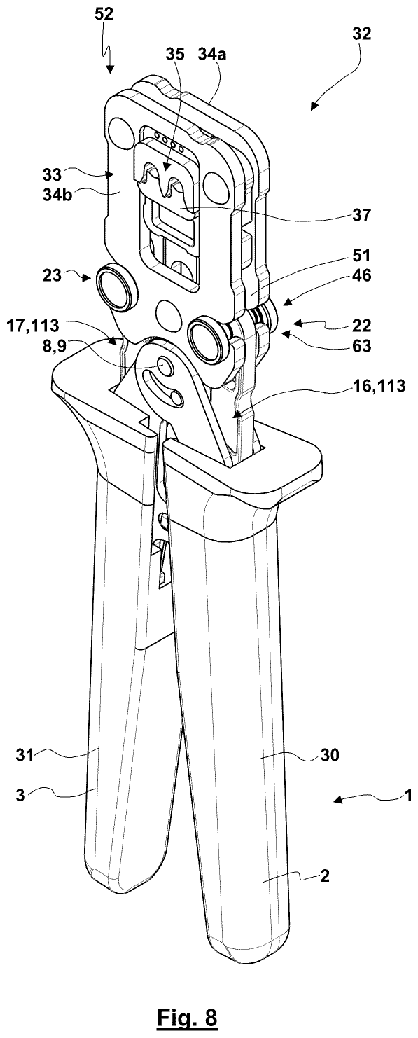

When a pair of pliers 52 formed by assembling the plier actuation assembly group 1 and the plier head 32 as shown in FIG. 7 is used to crimp or press a workpiece, the operator closes the hand levers 2, 3, causing a passing of the crimping or pressing stroke. FIG. 8 shows the pliers 52 at the end of the crimping or pressing stroke, at which the hand levers 2, 3 and the die halves 35, 37 are closed.

In FIGS. 7 and 8, it can be seen that in the assembled state in a direction vertical to the pliers head plane the frame plates 34a, 34b are each trapped between the base bodies 20, 21 and an extension 28, 29.

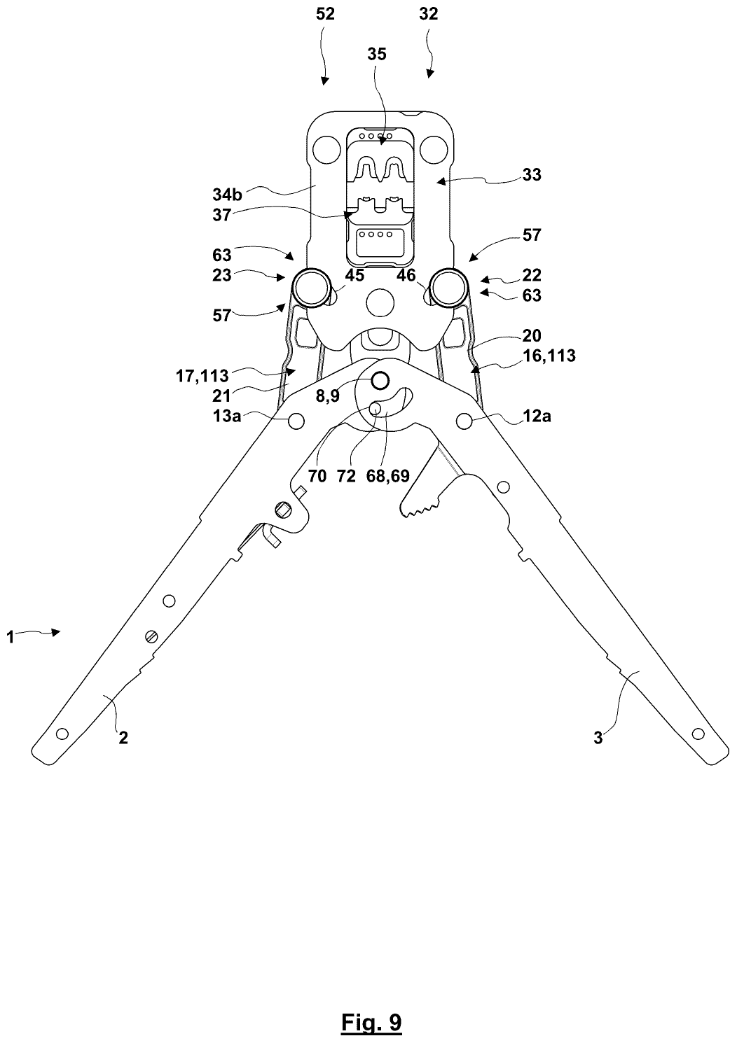

FIG. 9 shows the partially assembled state of the pliers 52 at the time the coupling elements 22, 23 enter the coupling recesses 45, 46, with some parts of the pliers 52 omitted here for better illustration.

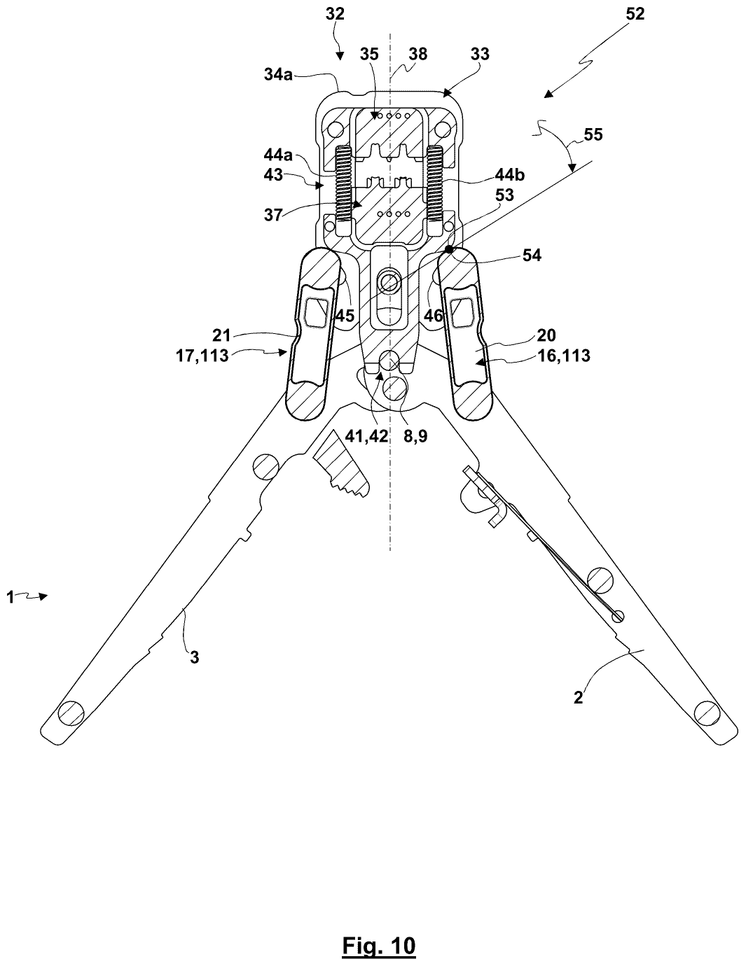

In a corresponding partial assembly position, FIG. 10 shows the pliers 52 in a sectional view in the plane of the dies 35, 37 and in the plane of the pliers head, in which the interaction of the pivot bolt 8 with the pivot bolt accommodation 41 and the contact force as a result of the springs 44a, 44b can be seen.

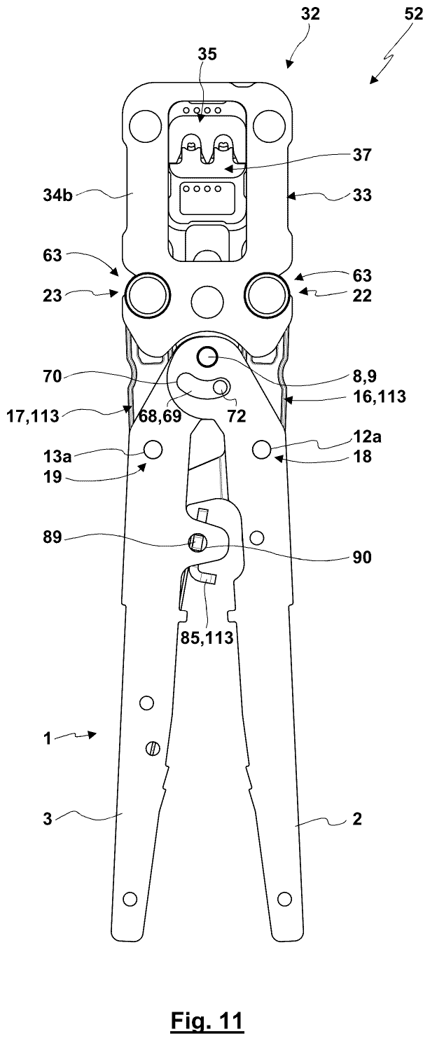

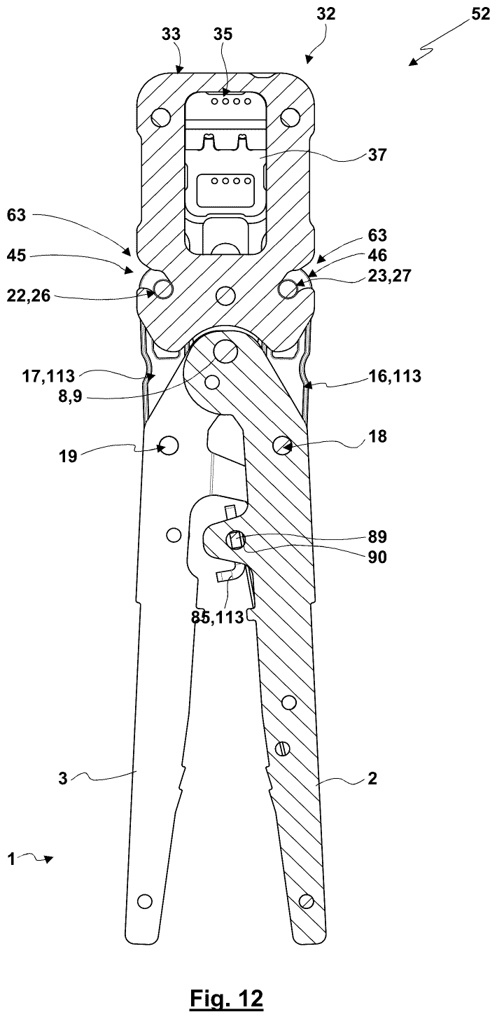

Finally, FIGS. 11 and 12 show illustrations corresponding to FIGS. 9 and 10, but here the pliers 52 are shown in the closed position at the end of the crimping or pressing stroke.

As an optional feature, when the coupling elements 22, 23 enter the coupling recesses 45, 46 or even earlier when the pulling bars 16, 17 approach the pliers head frame 33, a contact surface 53 of the pulling bars 16, 17, 4 of the base body 20, 21 can come into contact with a contact surface 54 of the movable die half 37 (cf. FIG. 10). An actuating force applied to the pulling bars 16, 17, which pivots the pulling bars 16, 17 inward, is converted by the contact surfaces 53, 54 into an actuating force component that provides an assembly assistance force that strives to move the movable die half 37 in the closing direction and to compress the springs 44a, 44b. For this purpose, the contact surfaces 53, 54 are inclined at an acute angle 55 with respect to the crimping or pressing axis 38. During the insertion movement, the contact surfaces 53, 54 slide along each other. The contact surfaces 53, 54 can also be curved as desired, resulting in an angle 55 that varies during the insertion movement.

FIG. 13 is a three-dimensional single component drawing of a pulling bar 16, 17, which forms the base body 20, 21, the protrusions 14a, 14b, 15a, 15b and the coupling elements 22, 23 as an integral, one-piece component. It can be seen here that the extensions 28, 29 are formed as disc bodies 56. It is possible that the extensions 28, 29 or disc bodies 56 form actuating elements 57 which simplify assembly and disassembly by providing that actuating forces required for assembly and disassembly and movement of the pulling bars 16, 17 can be applied to them by the user.

The coupling recesses 45, 46 can be of any shape. They do not have to be formed as an elongate hole 49. Rather, it is crucial that the coupling recesses 45, 46 form upwardly oriented hooks or suspension eyes in which the coupling elements 22, 23 can be suspended. The embodiment according to FIGS. 1 to 13 represents a possible embodiment of the above “first variant”.

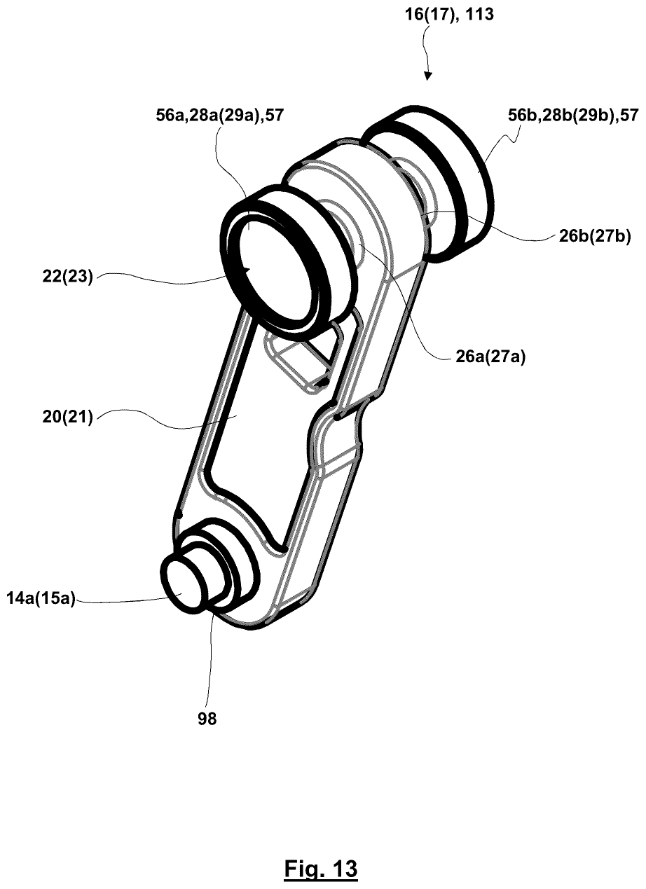

In FIGS. 14 to 21, a further embodiment of the pliers actuation assembly group 1, the pliers head 32 and the pliers 52 formed with the pliers actuation assembly group 1 and the pliers head 32 is shown, which represents a possible embodiment of the above “second variant”. Here, the same reference numbers are used for structurally or functionally corresponding or similar components and features as in FIGS. 1 to 13, and reference is made to the description thereof.

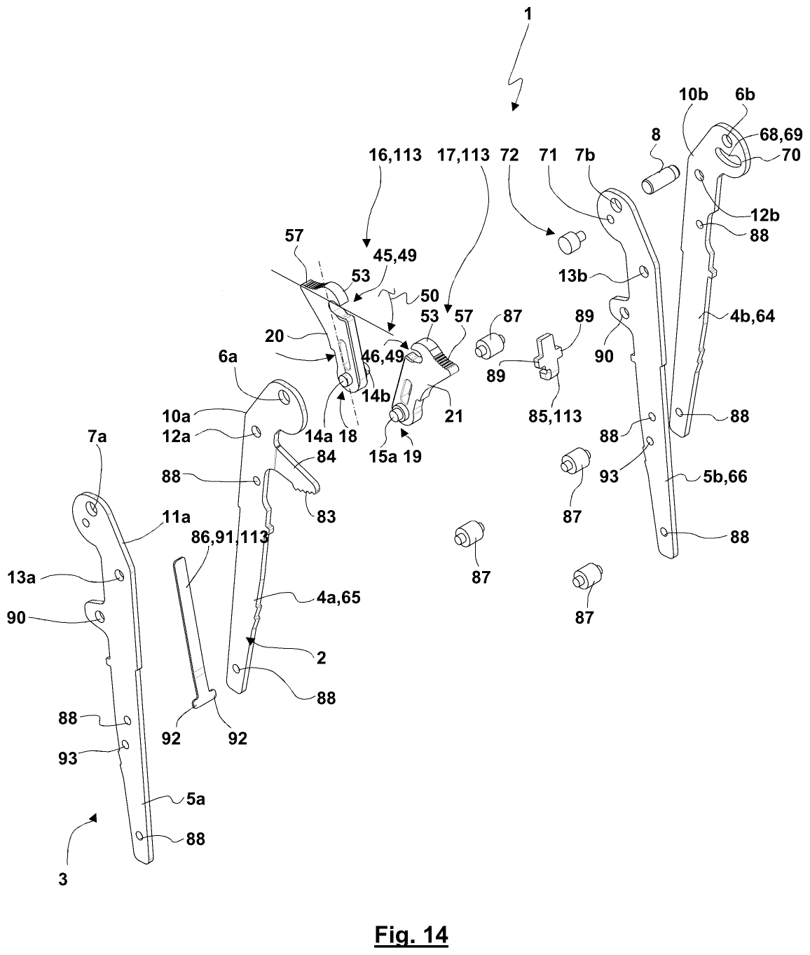

The pliers actuation assembly group 1 shown in FIGS. 14 and 15 has pulling bars 16, 17 that do not have coupling elements 22, 23 embodied as coupling pins 26, 27. Instead, for this embodiment, the pulling bars 16, 17 comprise coupling recesses 45, 46, which are formed here as an elongated hole 49 open on one side. In this case, the coupling recesses 45, 46 are inclined at an acute angle 50 with respect to a radial direction to the pivot axis of the pivot bearings 18, 19 through the bottom of the coupling recess 45, 46, the acute angle preferably being in the range of 30° to 85° or 40° to 80° or 50° to 80°. As can be seen, in this case the base body 20, 21 of the pulling bars 16, 17 has lateral protrusions forming the actuating elements 57. Otherwise, the pliers actuation assembly group 1 is designed in accordance with the pliers actuation assembly group 1 shown in FIGS. 1 and 2 and described with respect thereto.

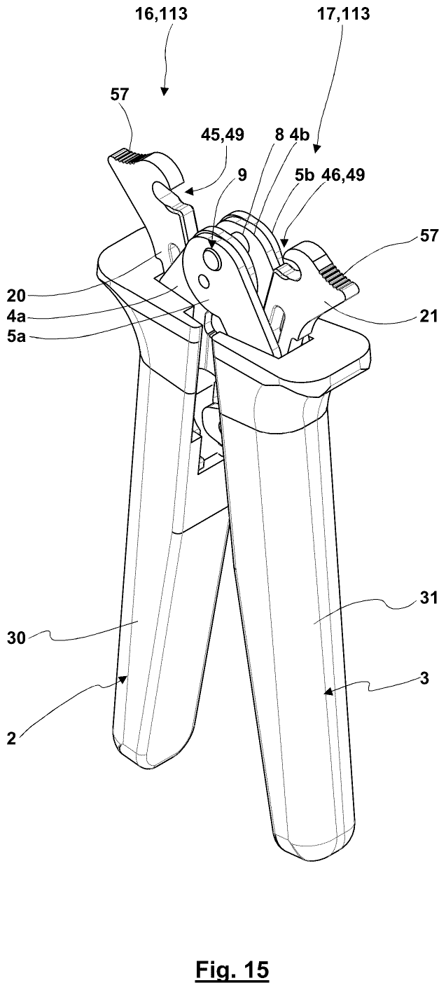

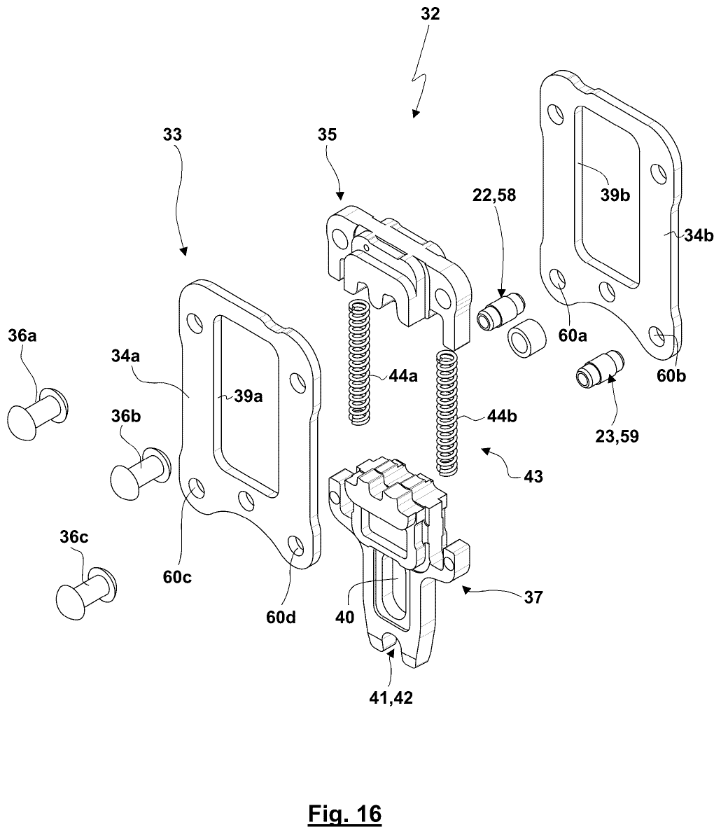

FIGS. 16 and 17 show the pliers head 32 for this embodiment. Here, the pliers head frame 33 does not have coupling recesses 45, 46. Instead, the pliers head frame 33 has coupling elements 22, 23 in the lower end region facing the pliers actuation assembly group 1 in the assembled state, which are formed as coupling pins 58, 59. Preferably, the coupling pins 58, 59 are multifunctional, in that they serve on the one hand as coupling elements for a coupling with the pliers actuation assembly group 1 and on the other hand serve for a connection to the frame plates 34a, 34b. For the embodiment shown, the coupling pins 58, 59 are stepped in the two end regions and are accommodated in a precisely fitting manner in corresponding accommodations 60a, 60b, 60c, 60d of the frame plates 34a, 34b, which are designed here as bores.

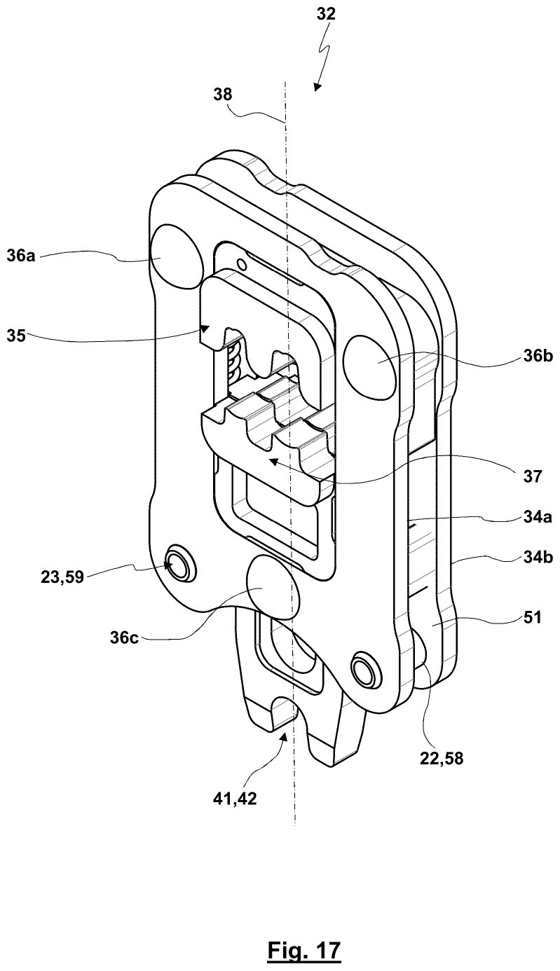

FIGS. 18 to 21 show the pliers 52 formed with the pliers head 32 and the pliers actuation assembly group 1 in various states of assembly:

According to FIG. 18, the pliers head 32 is disassembled from pliers actuation assembly group 1. The pivot bolt accommodation 41 of the pliers head 32 is freely accessible on the side facing the pliers actuation assembly group 1. The pivot bolt 8 and the pulling bars 16, 17 of the pliers actuation assembly group 1 are also freely accessible on the side facing towards the pliers head 32. The pulling bars 16, 17 can be pivoted freely in the plane of the pliers head.

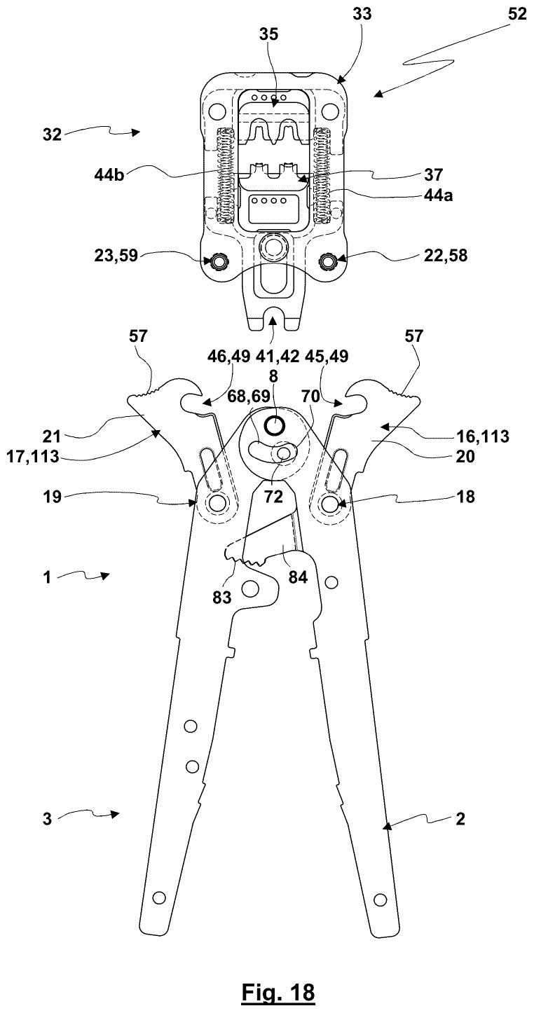

According to FIG. 19, the pliers actuation assembly group 1 has been approached to the pliers head 32 in such a way that the pivot bolt 8 enters the pivot bolt accommodation 41 and comes to rest against the bottom of the pivot bolt accommodation 41. In addition, the pulling bars 16, 17 are pivoted inwards, whereby the coupling pins 58, 59 of the pliers head 32 enter the coupling recesses 45, 46 of the pulling bars 16, 17. The length of the pulling bars 16, 17 is dimensioned in such a way that this entry is only possible when the movable die half 37 moves in the closing direction under the bias by the spring device 43. With regard to the extent of the closing movement and the force conditions what has been said with regard to the first embodiment applies accordingly.

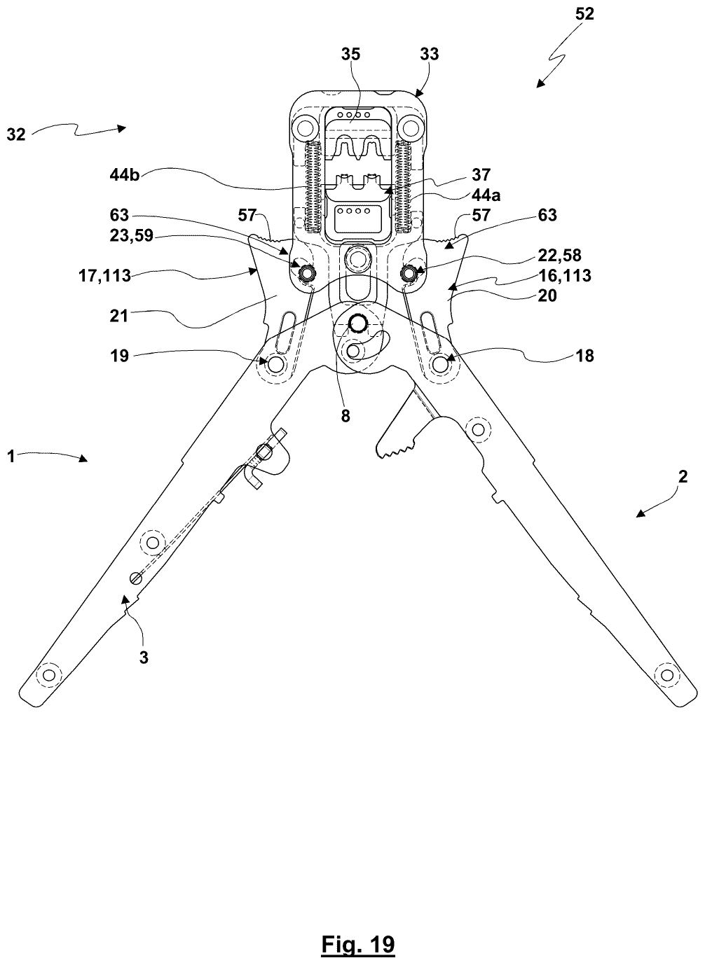

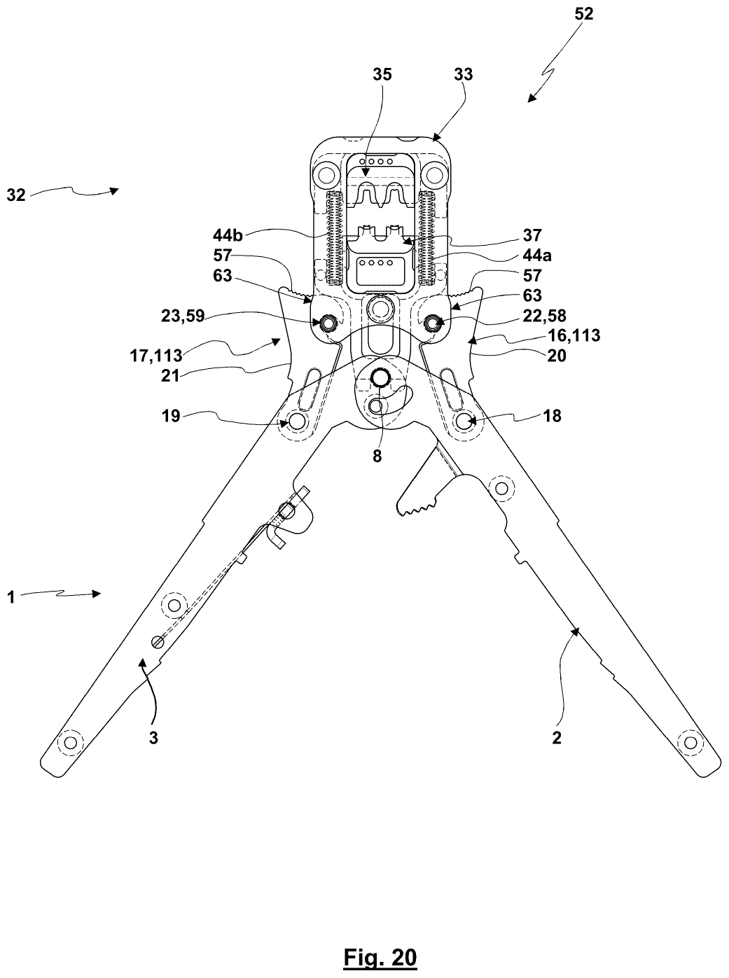

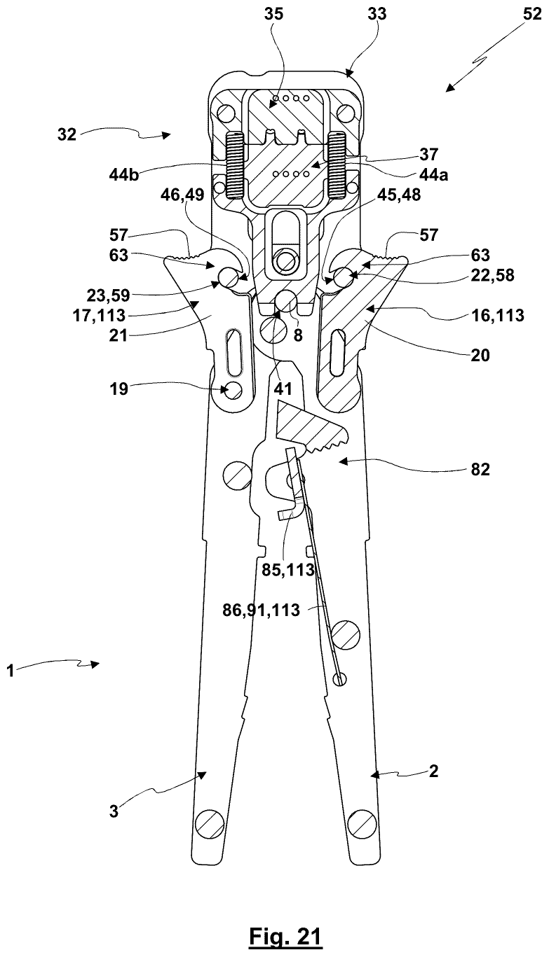

If the coupling pins 58, 59 contact the bottom of the coupling recesses 45, 46 in the fully assembled position as shown in FIG. 20, the spring device 43 secures the state assembled in this way. The pivoting of the hand levers 2, 3 towards each other then leads to the passage of the crimping or pressing stroke until the closed position shown in FIG. 21 is reached.

FIG. 22 shows the pulling bars 16, 17 as individual parts. The pulling bars 16, 17 are preferably formed in one piece with the base body 20, 21 and the protrusions 14, 15 as well as the actuating element 57. Preferably, the pulling bars 16, 17 are produced in a MIN manufacturing process.

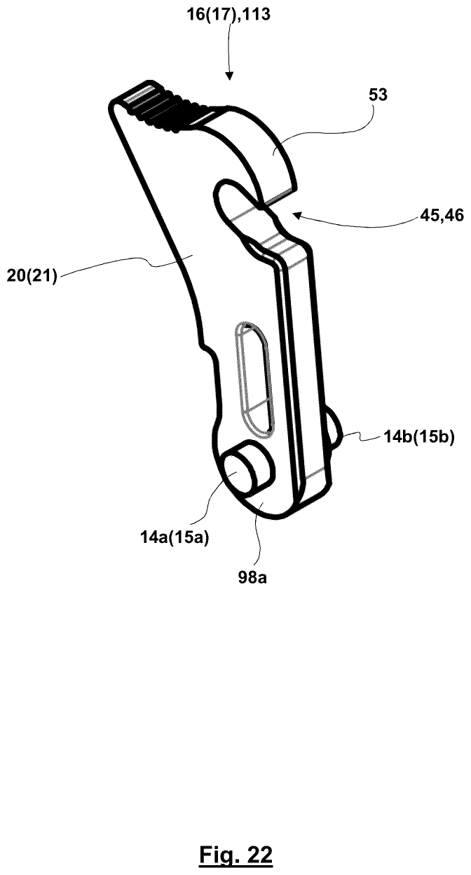

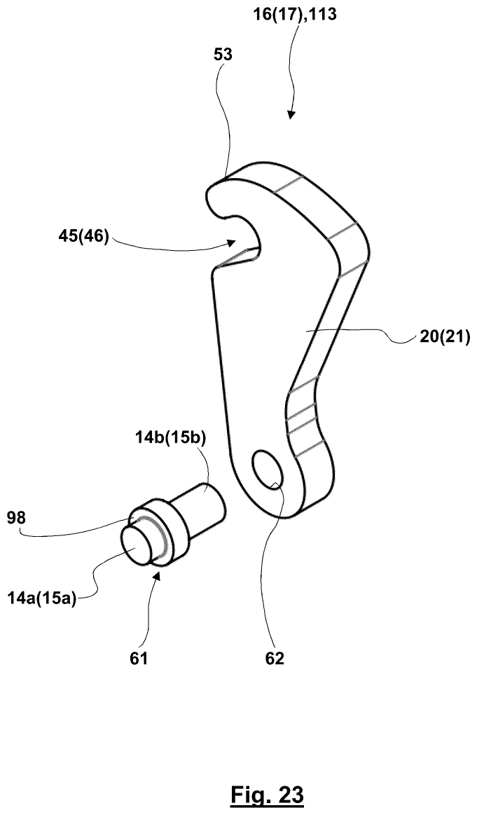

FIG. 23 shows an alternative design of the pulling bars 16, 17, wherein the base bodies 20, 21 and a pivot bolt 61 which forms the protrusions 14, 15 are formed separately from one another. In this case, the base body 20, 21 can be manufactured, for example, as a milled or stamped part. The base body 20, 21 then has a bore 62 in which the pivot bolt 61 is accommodated with a fit, for example by means of a press fit.

Also for this embodiment, the pulling bars 16, 17 may have a contact surface 53 that comes into contact with a contact surface 54 of the movable die half 53 when the pulling bars 16, 17 are pivoted inward. The contact surface may generate an actuation force component that causes the movable die half 37 to move in the closing direction to allow the coupling pins 58, 59 to enter the coupling recesses 45, 46.

The coupling recesses 45, 46 and the coupling elements 22, 23 form coupling devices 63 by means of which the pliers head 32 can be assembled with and disassembled from the pliers actuation assembly group 1 (in particular without the use of any tool).

FIG. 24 shows a pliers actuation assembly group 1 in a three-dimensional exploded view, wherein the pliers actuation assembly group 1 basically corresponds to the embodiment described in FIGS. 14 to 23. However, the following also applies mutatis mutandis for an embodiment corresponding to the embodiment of FIGS. 1 to 13.

In the nomenclature on the one hand of the patent claims and on the other hand of the preceding description od the figures, the hand lever plate 4b of the hand lever 2 forms a first hand lever plate 64, the hand lever plate 4a of the hand lever 2 forms a second hand lever plate 65, the hand lever plate 5b of the hand lever 3 forms a third hand lever plate 66, and the hand lever plate 5a of the hand lever 3 forms a fourth hand lever plate 67.

The first hand lever plate 64 has a recess 68 embodied as an elongated hole 69. An end region of the elongated hole 69 forms a stop 70. The elongated hole 69 has a longitudinal axis curved in the shape of an arc of a circle, which runs concentrically to the pivot axis of the two hand levers 2, 3 defined by the pivot bolt 8.

The third hand lever plate 66 has a holding and/or guiding recess, which is here embodied as a holding and/or guiding bore 71. The distance of the holding and/or guiding bore 71 from the pivot axis defined by the pivot bolt 8 corresponds to the distance of the elongated hole 69 from the pivot axis defined by the pivot bolt 8.

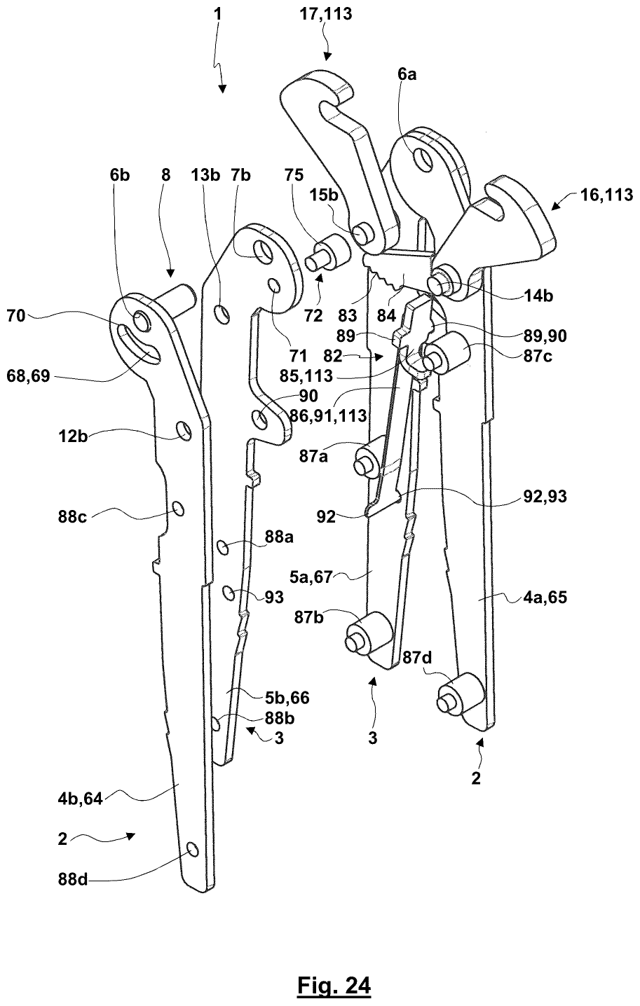

FIG. 25 shows a stop part 72. The stop part 72 comprises or consists of a first longitudinal cylindrical longitudinal section 73 having a first diameter and a second cylindrical longitudinal section 74 having a second diameter being larger than the first diameter. The longitudinal sections 73, 74 are arranged coaxially with respect to each other. The transition from the first longitudinal section 73 to the second longitudinal section 74 is provided by a shoulder 75, which is formed here by a circular ring surface 76. With the assembly, the first longitudinal section 73 is inserted into the holding and/or guiding bore 71 from the inside, i.e. from the side of the second and fourth hand lever plates 65, 67, whereby in particular a radial guidance of the stop part 71 is provided and the position of the stop part 72 in the pivoting plane of the hand levers 2, 3 is defined as well as the orientation of the stop part 72 vertically to this pivoting plane is guaranteed. The stop part 72 is inserted into the holding and/or guiding bore 71 to such an extent that the shoulder 72 comes into contact with the third hand lever plate 66 on the inner side of the third hand lever plate 66, i.e. on the side facing towards the hand lever plates 65, 67. In this way the free end region of the first longitudinal section 73 protrudes from the third hand lever plate 66 and is arranged in the elongate hole 69. Preferably, the front side of the first longitudinal section 73 is arranged flush with the outer surface of the first hand lever plate 64.

The free end face of the second longitudinal section 74 forms a support surface 77 (circular in this case). In the assembled state of the pliers actuation assembly group 1, the support surface 77 contacts the second hand lever plate 65. In the direction of insertion of the stop part 72 into the third hand lever plate 66, in the assembled state the stop part 72 is secured by the abutment of the shoulder 75 against the third hand lever plate 66, while a securing in the opposite direction is provided by the abutment of the support surface 77 against the second hand lever plate 65, so that the stop part 72 is trapped between the second hand lever plate 65 and the third hand lever plate 66.

FIG. 26 shows a three-dimensional representation of the pivot bolt 8. It can be seen here that the pivot bolt 8 has a first cylindrical longitudinal section 78 and a second cylindrical longitudinal section 79, which are separated from each other by a shoulder 80, which is formed as an annular ring surface 81.

When assembling the pliers actuation assembly group 1, the pivot bolt 8 is inserted with the first longitudinal section 78 into the bearing eye 6b until the annular ring surface 81 on the inside comes into contact with the first hand lever plate 64. Subsequently, the second, third and fourth hand lever plates 65, 66, 67 are pushed with the bearing eyes 7b, 6a, 7a onto the pivot bolt 8.

For the embodiment shown, the pliers actuation assembly group 1 has a forced locking mechanism 82. Such a forced locking mechanism 82 serves to ensure that a partially closed position of the hand levers 2, 3, once reached, is secured in several partial stages during the pressing or crimping stroke, so that no opening movement of the hand levers 2, 3 is possible even if the manual forces applied to the hand levers 2, 3 are reduced. Instead, the forced locking mechanism 82 only allows an opening movement of the hand levers 2, 3 when the pressing or crimping stroke has been completed or when it has reached a defined closed position.

The forced locking mechanism 82 has toothing 83, which is formed here by an protrusion 84 of the second hand lever plate 65. Furthermore, the forced locking mechanism 82 has a locking pawl 85. The locking pawl 85 is pivotably mounted and is biased by a spring 86. The locking pawl 85 interacts with the toothing 83 in such a way that during the closing movement of the hand levers 2, 3, when a partial closing position to be secured is reached, the locking pawl 85 has passed a tooth of the toothing 83 in a ratchet-like manner, while the locking pawl 85 blocks an opening movement by suitable support on the tooth that has passed. Once the locking pawl 85 has passed all the teeth of the toothing 83 with the completion of the closing stroke, the locking pawl 85 can fold over, allowing the locking pawl 85 to pass the toothing 83 of the hand levers 2, 3 in a ratchet-like manner during an opening movement that is then made possible.

The assembly of the pliers actuation assembly group 1 is described below, the corresponding applying to the embodiments shown in FIGS. 1 to 23:

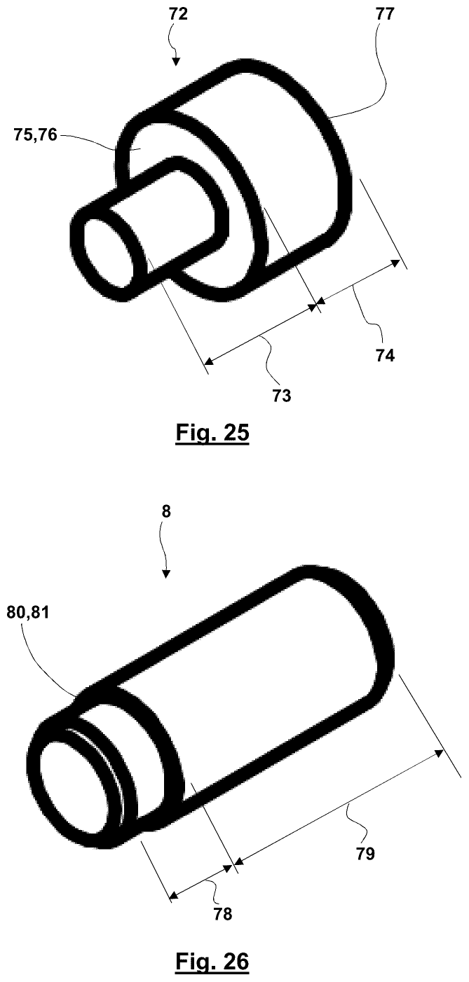

Assembly begins with the provision of the first hand lever plate 64 (cf. FIG. 27).

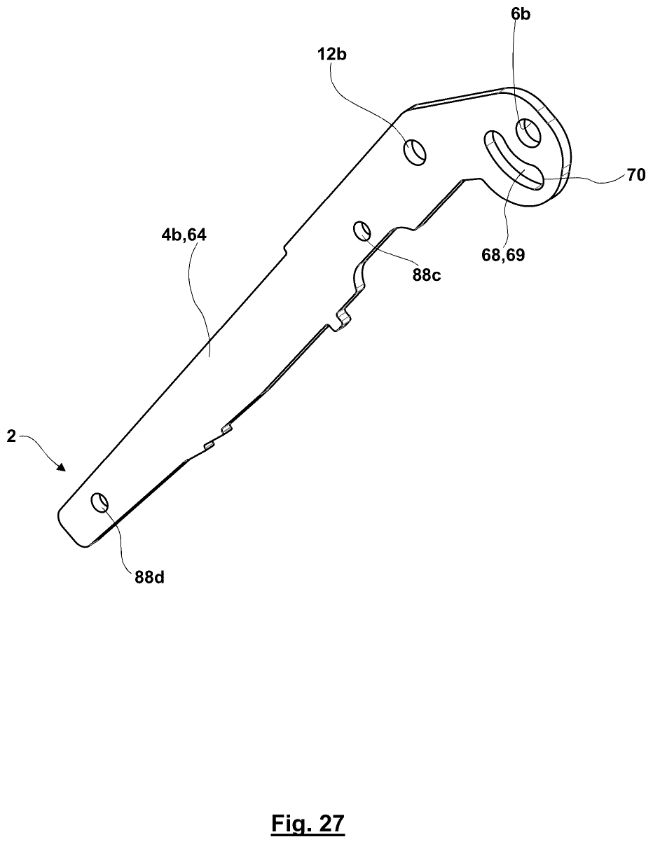

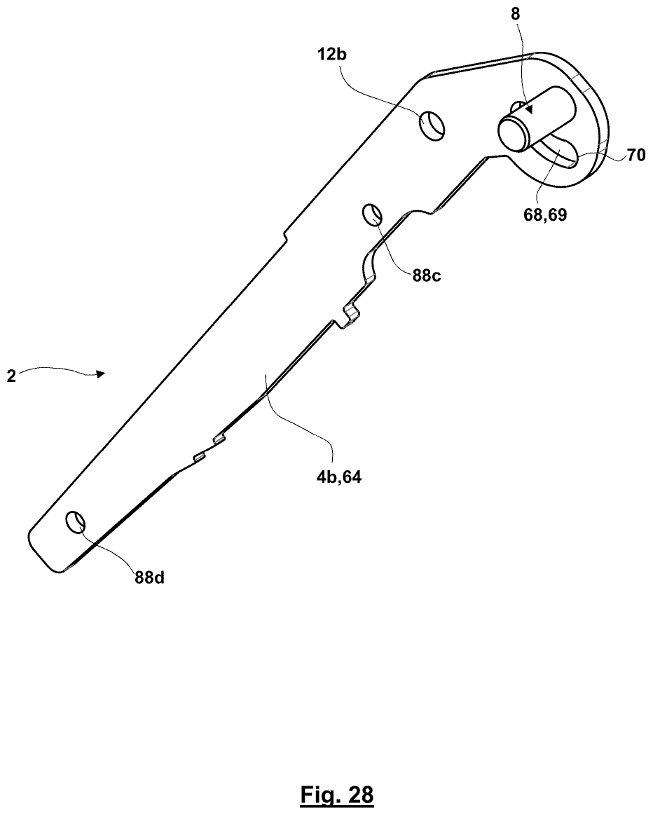

The first longitudinal section 78 of the pivot bolt 8 is then inserted into the bearing eye 6b of the first hand lever plate 64 from the inside of the first hand lever plate 64 until the shoulder 80 of the pivot bolt 8 comes into contact with the hand lever plate 64 (cf. FIG. 28).

Subsequently, the third hand lever plate 66 is pushed from the inside onto the pivot bolt 8, whereby the pivot bolt 8 enters the bearing eye 7b. FIG. 29 shows the end position of the third hand lever plate 66, in which the first and third hand lever plates 64, 66 rest against each other in a sliding manner under the guidance by the pivot bolt 8.

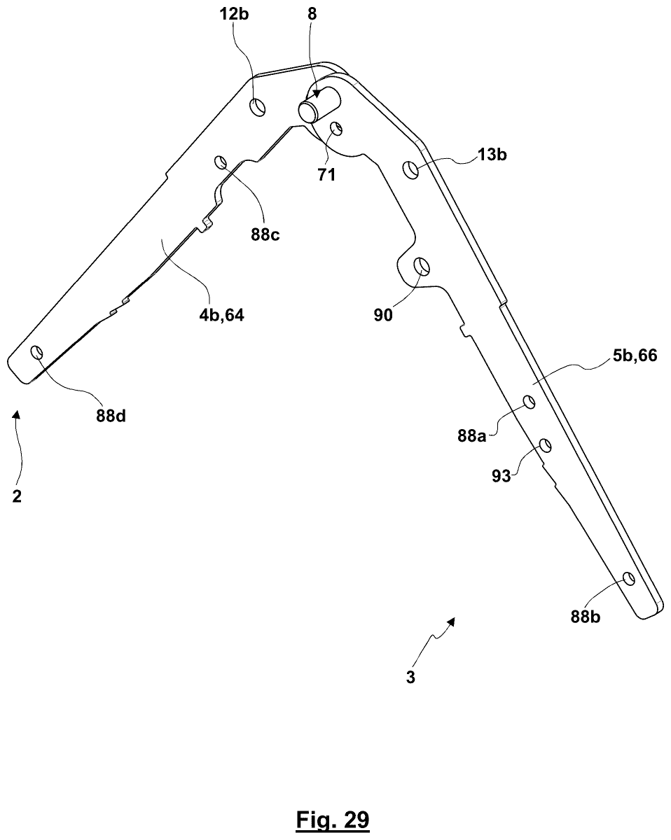

In the next assembly step, the first longitudinal section 73 of the stop part 72 is inserted from the inside into the holding and/or guiding bore 71 and guided through it until the free end region of the first longitudinal section 73 is received in the elongated hole 69 (cf. FIG. 30).

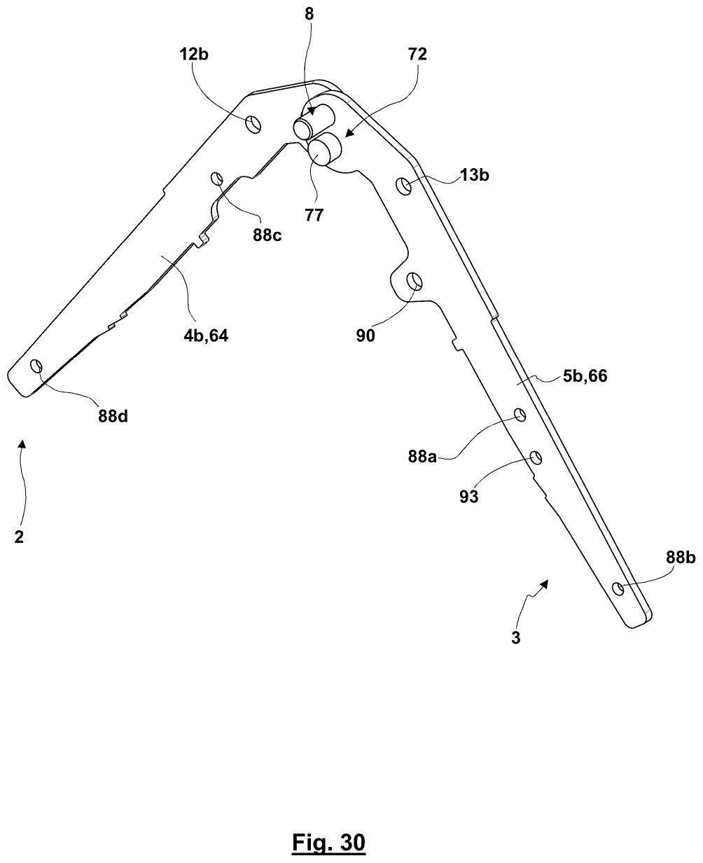

Referring to FIG. 31, spacers 87a, 87b, 87c, 87d are then inserted into accommodations 88a, 88b, 88c, 88d. For the embodiment shown, the spacers 87 each have a central cylindrical longitudinal section, the longitudinal extension defining the distance of the second hand lever plate 65 from the third hand lever plate 66, and each have cylindrical end sided longitudinal sections which form pins or journals which are accommodated in the accommodations 88 of the hand lever plates 64, 66 (and later also of the hand lever plates 65, 67), which are embodied as bores. In this case, the pins or journals have a smaller diameter than the central longitudinal section, so that the central longitudinal section transits to the pins or journals via a shoulder, here in the form of a circular ring surface. These shoulders are then trapped between the second and third hand lever plates 65, 66, whereby the spacers 87 between the hand lever plates 65, 66 are secured against disassembly in a direction vertical to the pivot plane of the hand levers 2, 3. The spacers 87 then define the interspace between the pairs of hand lever plates 64, 66 and 65, 67, which can be pivoted relative to one another.

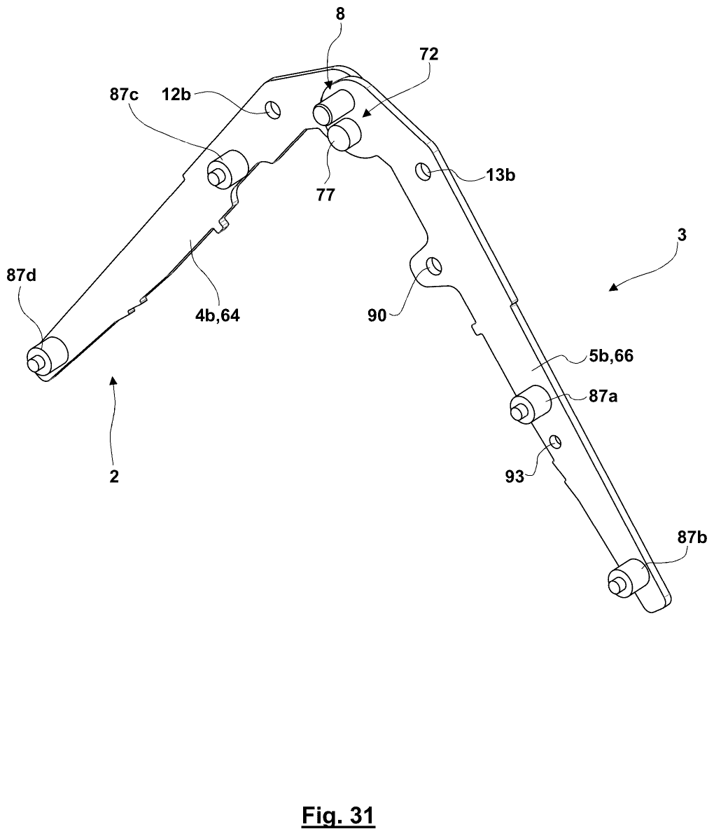

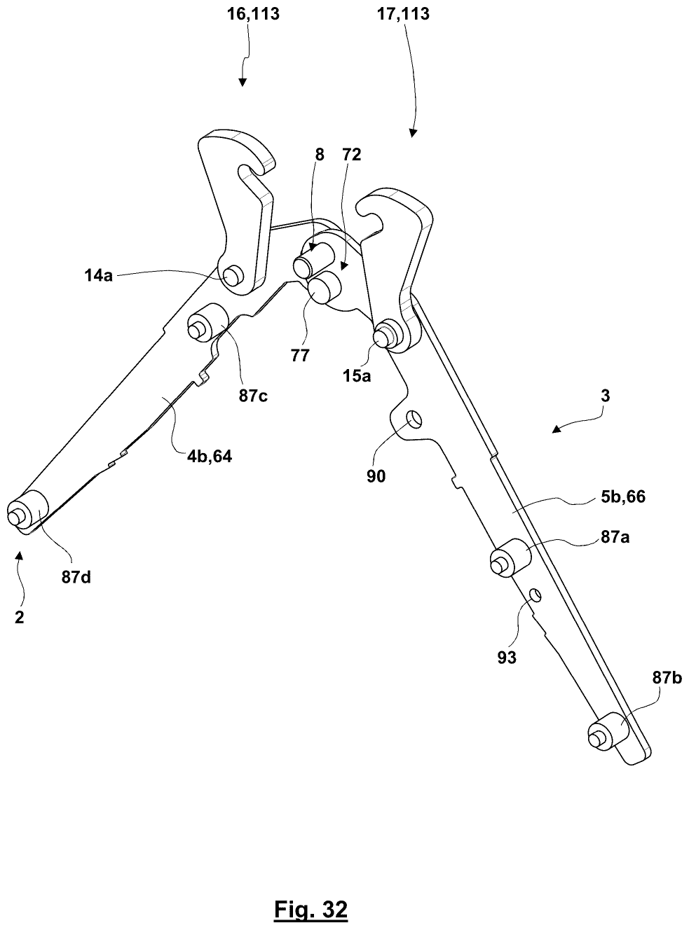

According to FIG. 32, the protrusions 14b, 15b of the pulling bars 16, 17 are then inserted into the accommodations 12b, 13b.

In the next assembly step, the second hand lever plate 65 is joined. During this joining step, the bearing eye 6a of the second hand lever plate 65 is pushed onto the pivot bolt 8. At the same time, the protrusion 14a enters into the accommodation 12a of the second hand lever plate 65 and the pins of the spacers 87a, 87b enter into the recesses 88c, 88d of the second hand lever plate 65. The assembly state then achieved is shown in FIG. 33.

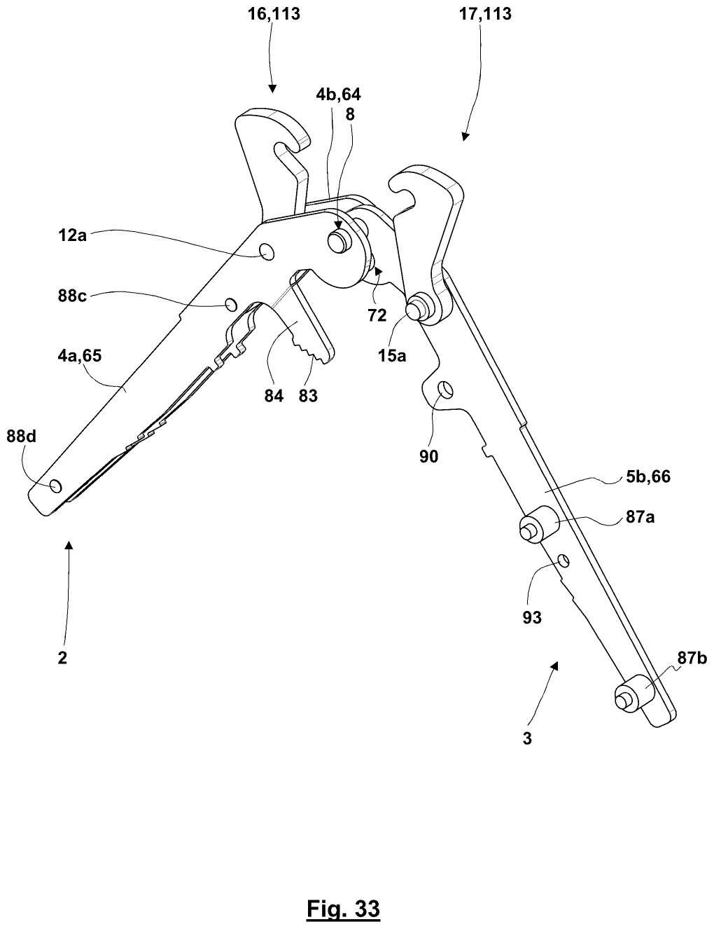

In the next assembly step, the locking pawl 85 is assembled with the third hand lever plate 66 by accommodating a protrusion 89 of the locking pawl 85 in an accommodation 90 of the third hand lever plate 66 (cf. FIG. 34).

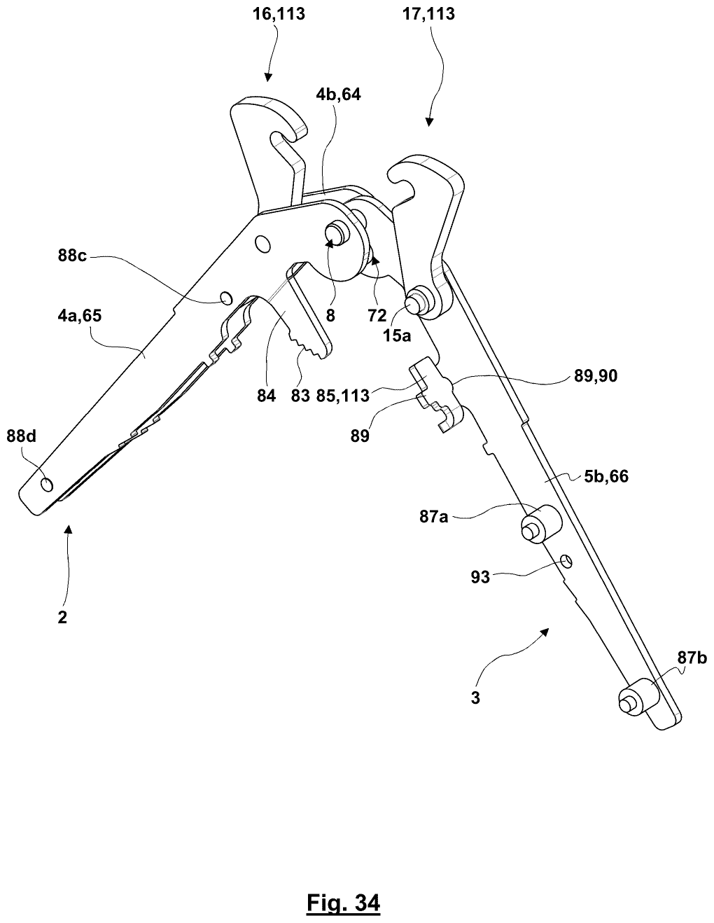

Subsequently, the spring 86 is assembled. In the embodiment shown, the spring 86 is T-shaped. The vertical leg of the T forms leaf spring 91 and the two horizontal legs of the T each form a protrusion 92. One protrusion 92 is received in an accommodation 93 of the third hand lever plate 66. Furthermore, the spring 86 is supported adjacent to the protrusion 92 on a spacer 87 in the bending direction of the leaf spring 91. The leaf spring 91 protrudes freely and is supported in the end region facing away from the protrusion 92 on the locking pawl 85 under the bias of the latter (see FIG. 35).

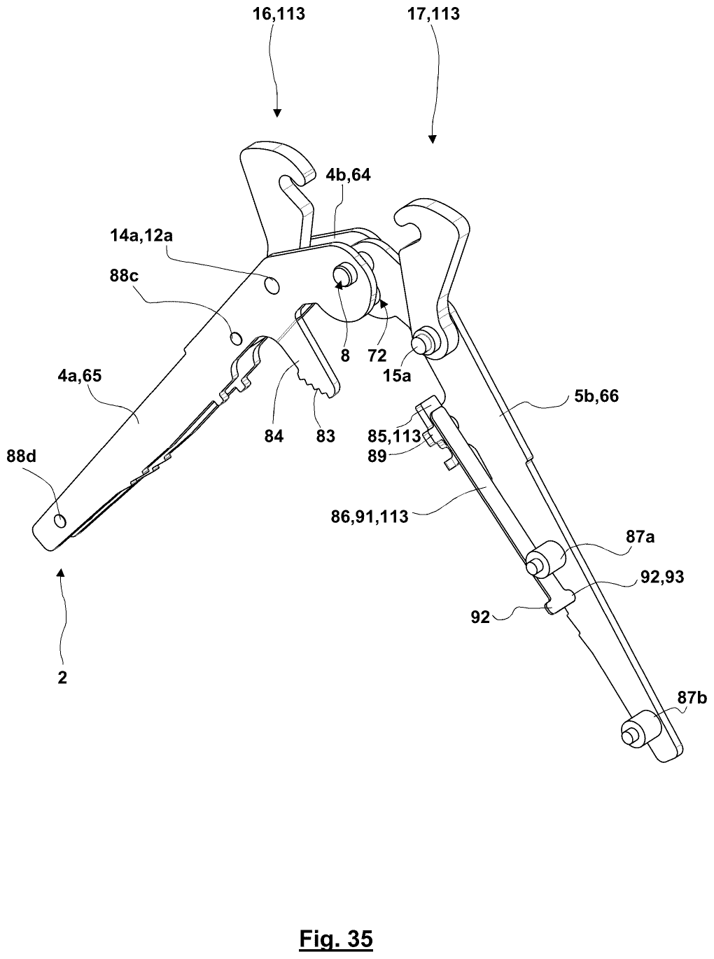

Subsequently, the fourth hand lever plate 67 is mounted onto the pivot bolt 8. With this mounting, pins of the spacers 87c, 87d enter accommodations 88a, 88b of the fourth hand lever plate 67, a further protrusion 89 of the locking pawl 85 enters an accommodation 90 of the fourth hand lever plate 67 and a protrusion 15a enters an accommodation 13a of the fourth hand lever plate 67 (see FIG. 36).

In the assembly state reached in this way (or also partially already before), the hand lever plates 64, 65, 66, 67 are then fixed. This is done, for example, by pressing or clamping the spacers 87 in the accommodations of the hand lever plates 64, 65, 66, 67. In addition, the pivot bolt 8 can also be pressed fitted or clamped. However, this must be done while maintaining the degree of pivot freedom of the hand levers 2, 3.

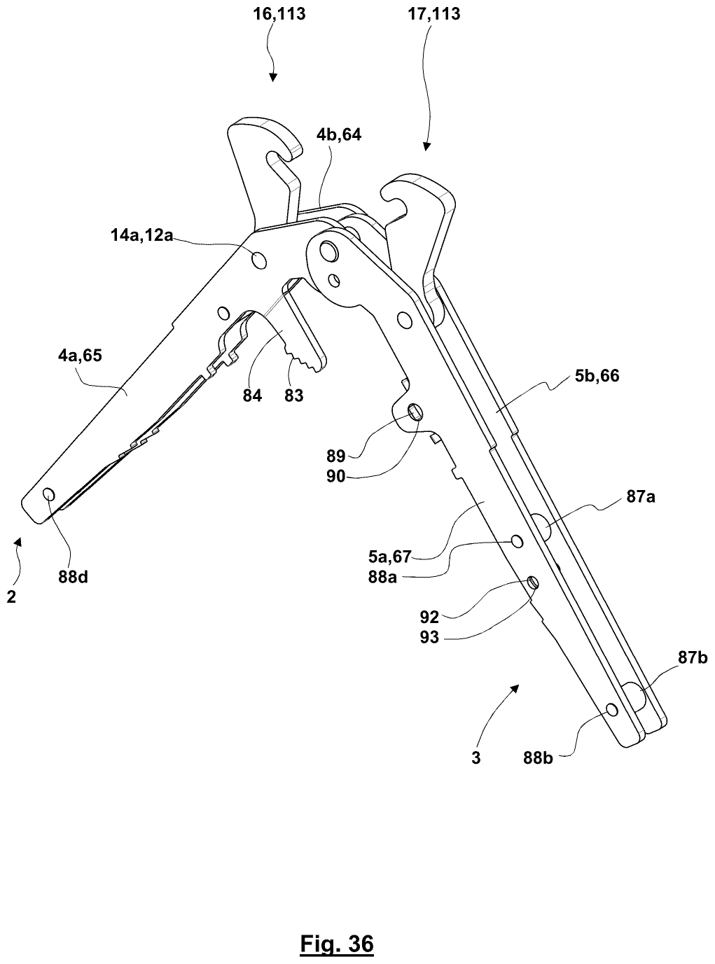

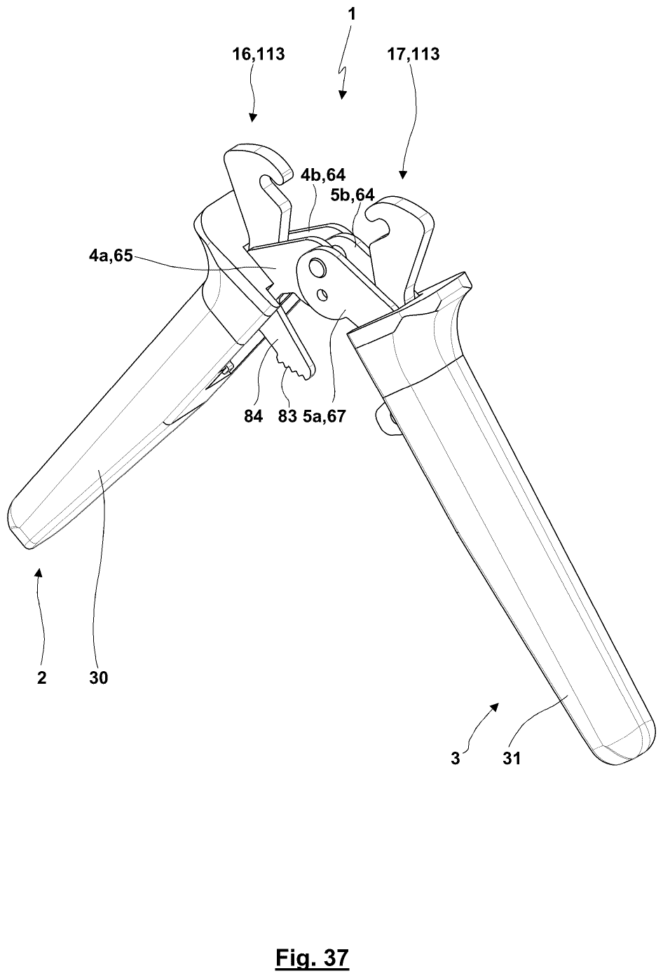

Finally, the handles 30, 31 are slid onto the hand lever plates 64, 65, 66, 67 (FIG. 37).

FIG. 38 shows a three-dimensional representation of a locking pawl 85. The locking pawl 85 is made of a bent metal sheet. The locking pawl 85 is integrally formed with a base body 95, an engaging part 96, aligned protrusions 97a, 97b that merge into the base body 95 via shoulders 98a, 98b, and an angled unlocking part 99.

FIG. 39 shows the spring 86 in a three-dimensional detail, which is T-shaped with two aligned protrusions 92a, 92b and a leaf spring 91.

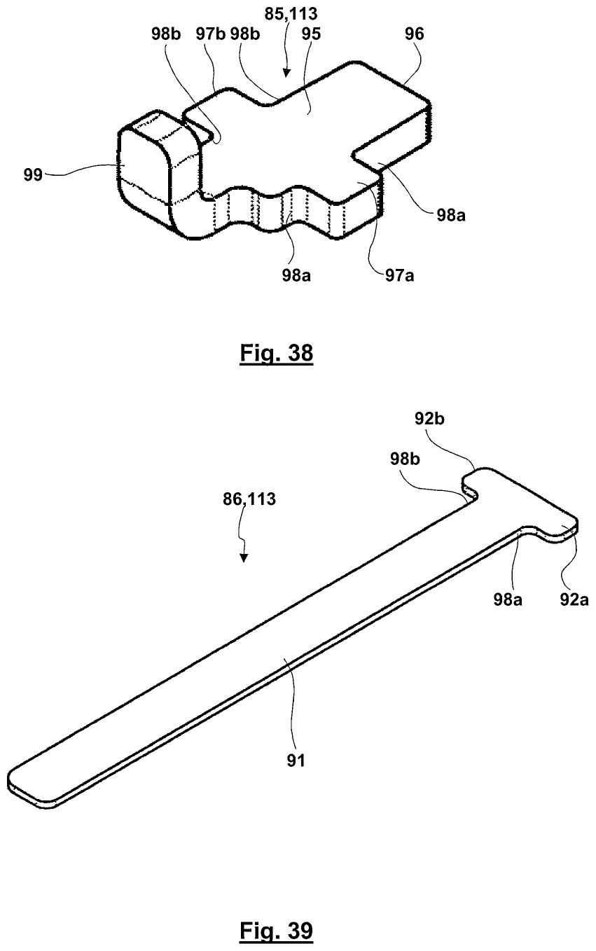

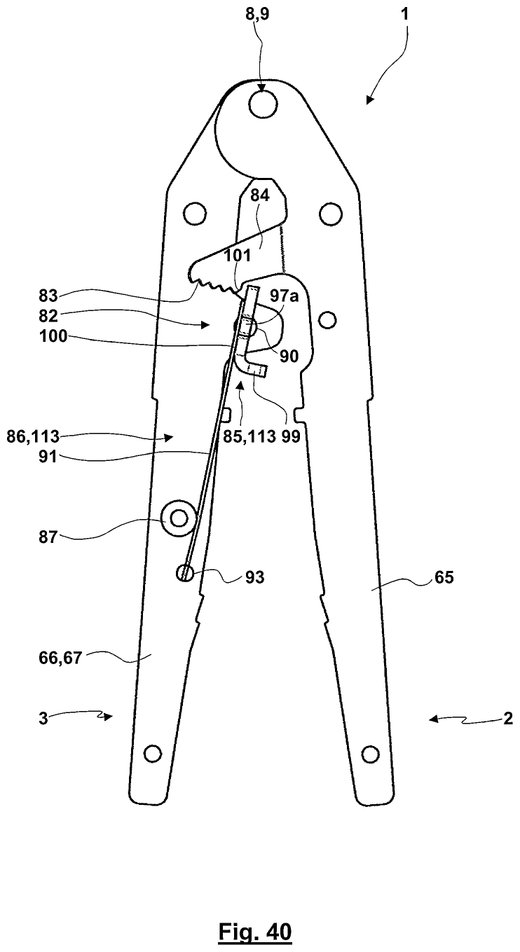

FIG. 40 shows a pliers actuation assembly group 1 in a partially cut or partially assembled state. The protrusions 92a, 92b are received in the accommodations 93 of the third and fourth hand lever plates 66, 67, whereby a spring base of the leaf spring 91 is pivotally fixed to the hand lever plates 66, 67. Adjacent to this spring base, the leaf spring 91 is supported on the cylindrical surface of a spacer 87.

The protrusions 97a, 97b of the locking pawl 85 are received in the accommodations 90 of the hand lever plates 66, 67, in this way a pivot bearing being formed. On one side of the base body 95 of the locking pawl 85, the end portion of the leaf spring 91 projecting freely beyond the spacer 87 is supported which is provided by the leaf spring 91 resting loosely against the base body 95. The contact surface between the locking pawl 85 and the leaf spring 91 forms an actuating part 100 of the locking pawl 85, via which the spring 86 acts on the locking pawl 85.

FIG. 40 shows the locking pawl 85 and the spring 86 in an intermediate position in which the bias of the spring 86 is minimal. The intermediate position corresponds to the closed position of the hand levers 2, 3, in which the locking pawl 85 has completely passed the toothing 83 of the hand lever plate 65.

FIG. 41 shows the pliers actuation assembly group 1 at the beginning of the closing stroke of the hand levers 2, 3, with the spring 86 and the locking pawl 85 in a securing position. In the securing position, during a closing movement of the hand levers 2, 3 the locking pawl 85 moves in a ratchet-like manner with the engaging part 96 along the toothing 83. The engagement of the engaging part 96 in the toothing 83 thereby blocks an opening movement of the hand levers 2, 3 when a partial closing position specified by the toothing 83 has been reached. Compared to the intermediate position in FIG. 40, the deflection of the leaf spring 91 is increased. At the end of the closing movement of the hand levers starting from FIG. 41, the intermediate position according to FIG. 40 is reached.

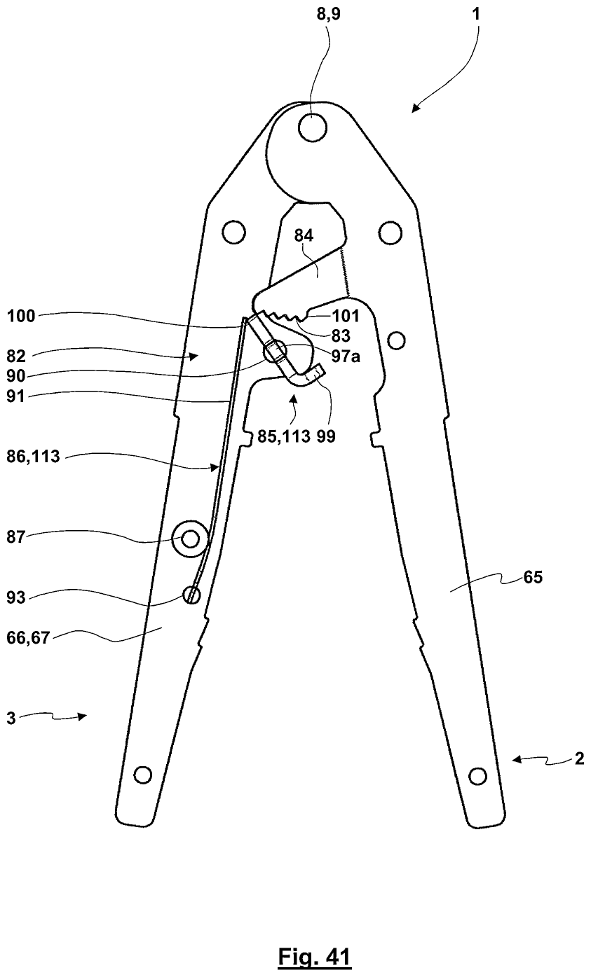

If, starting from the intermediate position according to FIG. 40 the opening movement of the hand levers 2, 3 takes place, the locking pawl 85 is folded over by a fold-over slope 101, which is arranged in the end region of the toothing 83, in a direction that is opposite to the fold-over from the intermediate position into the securing position according to FIG. 41. In the release position thus achieved according to FIG. 42, the engaging part 96 can be moved along the toothing 83 in a ratchet-like manner with the opening movement of the hand levers 2, 3.

Starting from the intermediate position according to FIG. 40, the deflection for the movement in the direction of the securing position according to FIG. 41 and in the direction of the release position according to FIG. 42 of the leaf spring 91 occurs in the same direction. The bias of the leaf spring 91 is minimal for the intermediate position according to FIG. 40 and increases in each case in the direction of the securing position according to FIG. 41 and in the direction of the release position according to FIG. 42, whereby the bias in the securing position according to FIG. 41 and the release position according to FIG. 42 can be the same or different. It can be seen in FIGS. 41, 42 that in the securing position and in the release position the leaf spring 91 contacts the locking pawl 85 at different locations or areas eccentrically to the pivot axis of the locking pawl 85. The contact surface and thus the actuating part 100 are arranged on different sides of the pivot axis in the securing position on the one hand and in the release position on the other.

If an emergency unlocking of the forced locking mechanism 82 is to be performed, the user can perform this by manually changing a position of the locking pawl 85 by acting directly with a finger on the angled unlocking part 99.

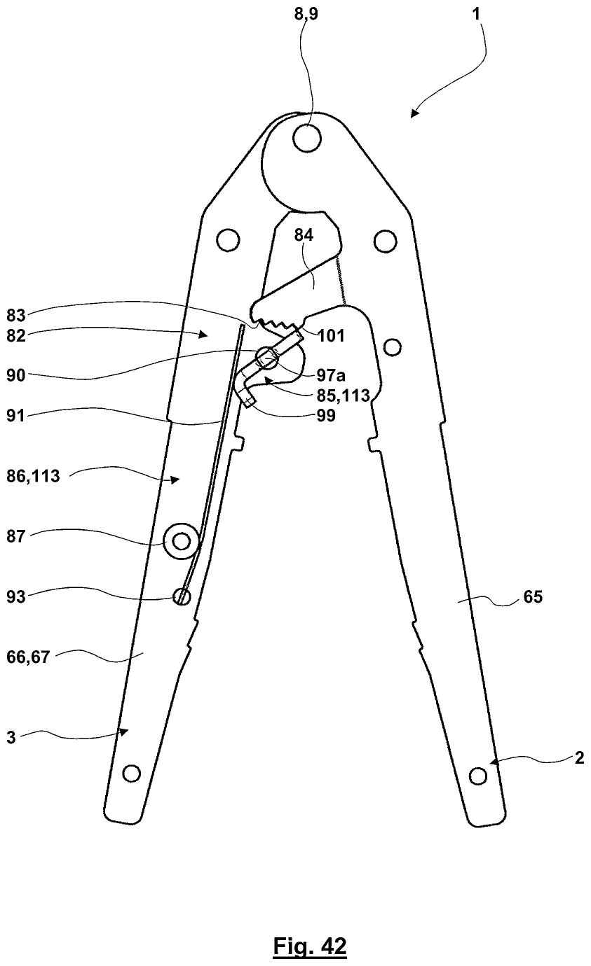

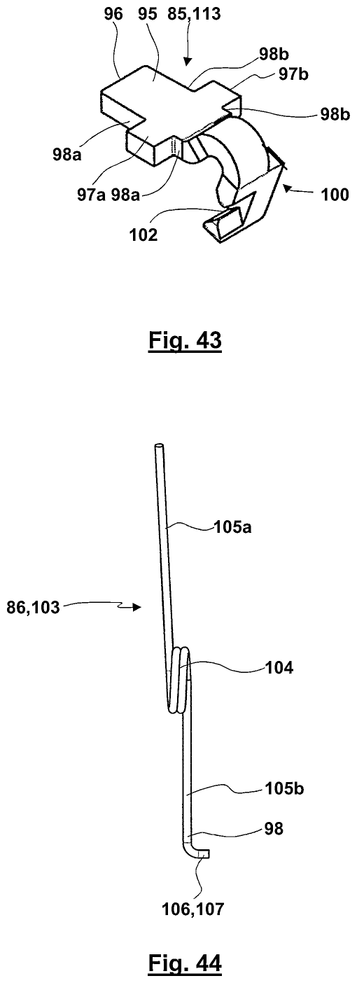

For the embodiment shown in FIG. 43, the actuating part 100 of the locking pawl 85 (which is also formed here as a one-piece bent metal sheet) is arranged at an angled section, which in this case is formed as an open-edged, for example U-shaped, laterally open recess 102. An end portion of the spring 86 may be disposed in the recess 102, as will be explained below. Preferably, in the area of the recess 102 the sheet metal comprises a phase, bevel or some kind of cutting edge in the area of the two lateral boundaries of the recess 102, thus allowing different angles between the spring 86 and the locking pawl 85 and forming a kind of pivot bearing connection (with a limited pivot angle).

According to FIG. 44, the spring 86 is embodied as a torsion leg spring 103. The torsion leg spring 103 is made of a spring wire. The torsion leg spring 103 has a winding 104 with a constant diameter and an arbitrary winding angle. For the example shown, the winding 104 is wound over a winding angle of, for example, 720°. Two legs 105a, 105b extend from the winding 104 in opposite directions. The legs 105a, 105b can be oriented coaxially or parallel to each other or can form any angle in the tensioned state of the spring 86. The end portion of the leg 105b facing away from the winging 104 is provided with an angled section 106 forming a protrusion 107. The angled section 106 and the protrusion 107 are oriented vertically to the bending plane and movement plane of the legs 105a, 105b and to the pivoting plane of the hand levers 2, 3.

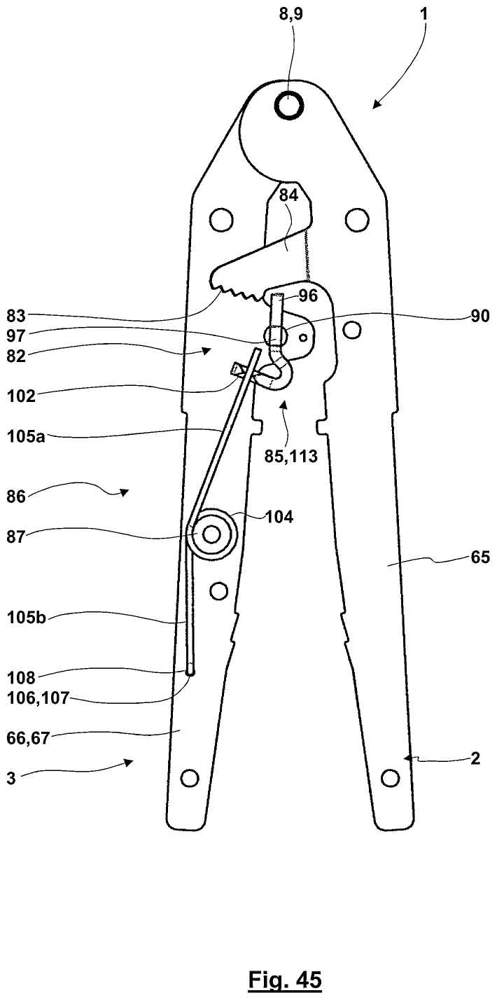

FIG. 45 shows a partially assembled or partially cut pliers actuation assembly group 1 with a forced locking mechanism 82 with the locking pawl 85 according to FIG. 43 and the spring 86 according to FIG. 44. It can be seen that the winding 104 extends around a spacer 87, so that the torsion leg spring 103 is rotatably mounted on the hand lever plate 66, 67 in the area of the winding 104. However, it is also possible that the spacer 87 is elastically clamped by the winding 104. The protrusion 107 formed by the angled section 106 is received in an accommodation 108 formed by the hand lever plate 66, which is here embodied as a bore. The free end portion of the other leg 105a is accommodated in the recess 102 of the locking pawl 85. In the intermediate position according to FIG. 45, in which the locking pawl 85 has completely passed the toothing 83 and has reached the closed position of the hand levers 2, 3, the leg spring 103 is not tensioned.

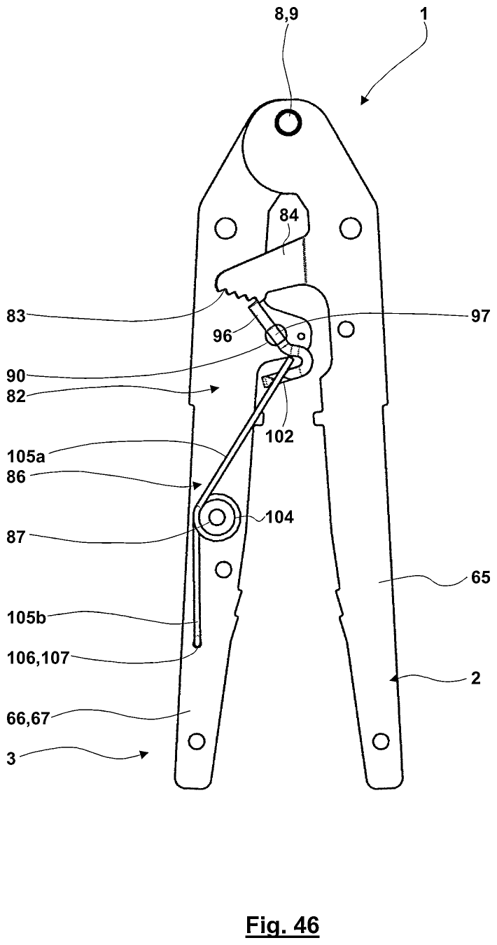

FIG. 46 shows the locking pawl 85 in the securing position. It can be seen here that the cutting-edge-like design of the limitation of the recess 102 of the locking pawl 85 allows the change of the relative angle between the leg 105a and the locking pawl 85.

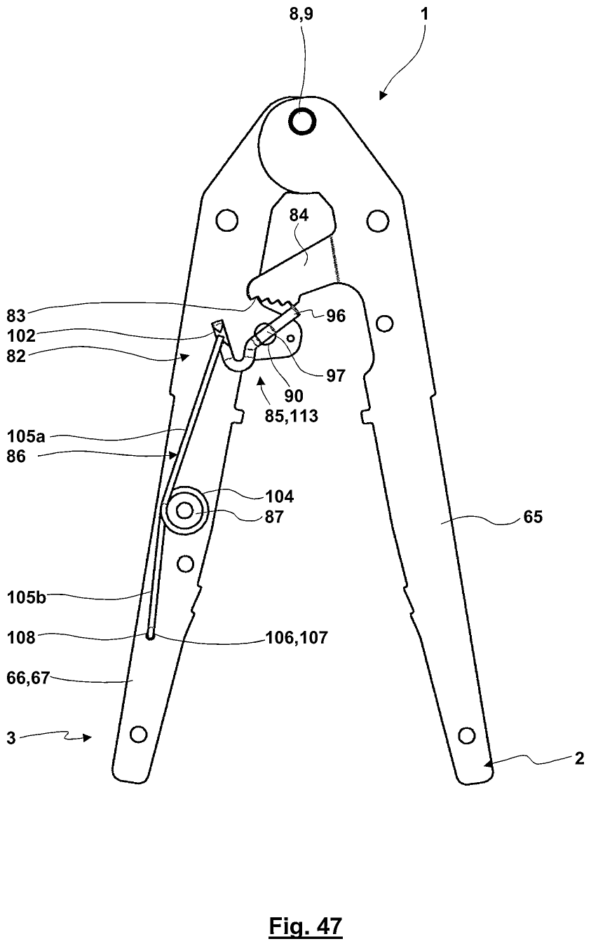

FIG. 47, on the other hand, shows the forced locking mechanism 82 in the release position. Here, too, the leg 105a of the leg spring 103 is Oust) arranged in the accommodation 102 of the locking pawl 85. Deviating from the previously explained embodiment according to FIGS. 40 to 42, here the locking pawl 85 is biased in different directions in the securing position on the one hand and in the release position on the other hand. Accordingly, the leg spring 103, in relation to the bending axis of the same in the securing position on the one hand and the release position on the other hand, is biased with bending moments that have different directional senses. However, it is also possible that the torsion leg spring 103 has a minimum loading in the release position [or in the securing position], which then increases in the direction of the securing position [or the release position].

According to FIG. 47, the torsion leg spring 103 is joined onto the spacer 87 in such a way that the legs 105a, 105b leave the winding 104 on the outside of the hand lever 3.

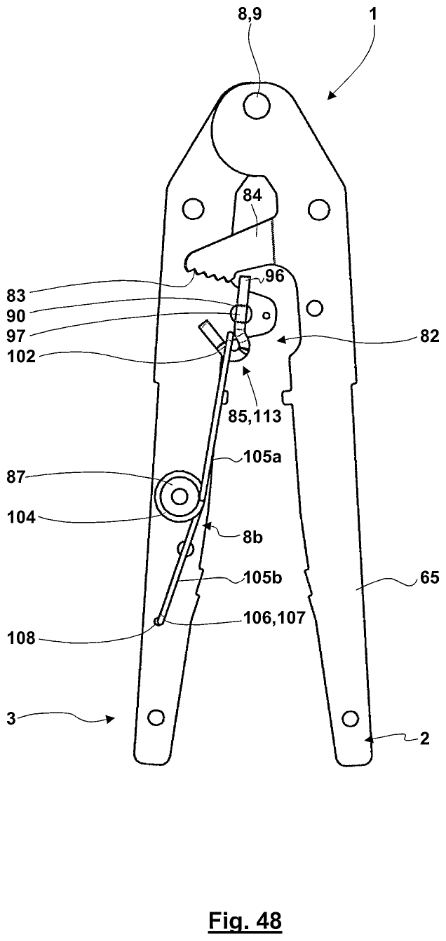

FIG. 48 shows that alternatively it is also possible that a different design and/or assembly of the torsion leg spring 103 is possible, in which the legs 105a, 105b leave the winding 104 on the inner side of the hand lever 3.

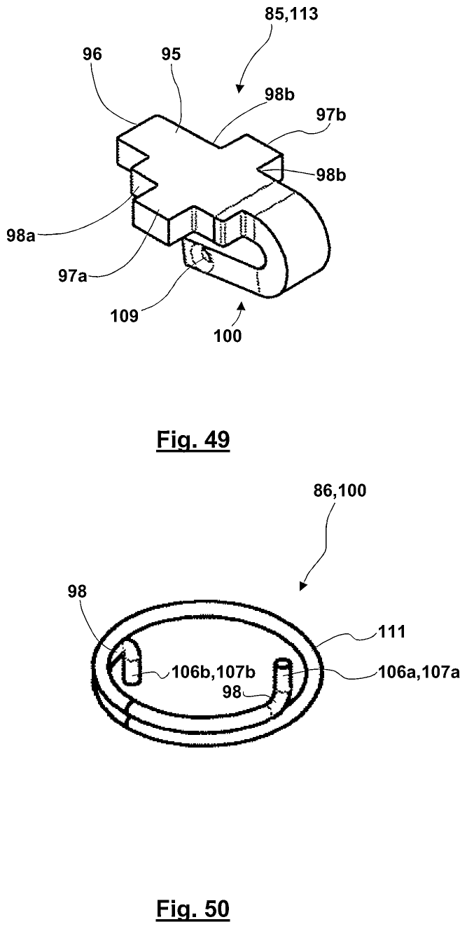

For the embodiment shown in FIG. 49, the actuating part 100 of the locking pawl 85 is bent in a U-shape so that an end region of the actuating part 100 extends parallel to the base body 95. For this embodiment, the locking pawl 85 has a lateral hole or accommodation 109 that extends parallel to the plane of extension of the metal sheet in this end region.

FIG. 50 shows an embodiment of the spring 86 as a circular spring 110 made of a spring wire. For the illustrated embodiment, a winding angle of a winding 111 of the circular spring 110 is, for example, 540°. The end regions of the circular spring 110 merge via angled sections 106a, 106b into protrusions 107a, 107b, wherein the protrusions 107a, 107b are oriented parallel to one another with opposite directions.

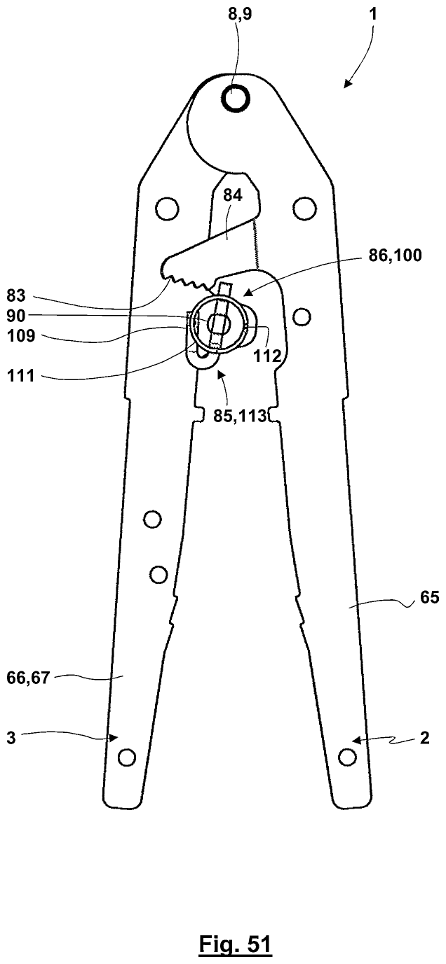

FIG. 51 shows the partially assembled or partially cut pliers actuation assembly group 1 with the locking pawl 85 according to FIG. 49 and the spring 86 according to FIG. 50. It can be seen here that the circular spring 110 extends with its main extension plane parallel to the pivoting plane of the hand levers 2, 3. One protrusion 107 is received in the accommodation 109 of the locking pawl 85, while the other protrusion 107 is received in an accommodation 112 of the hand lever plate 66, 67.

For the above embodiments
the pulling bars 16, 17,
the spring 86 of the forced locking mechanism 82 which biases the locking pawl 85 and
the locking pawl 85 of the forced locking mechanism 82

each constitute a mounting element 113 assembled in the proposed new way to the hand lever plates 64, 65, 66, 67.

Many variations and modifications may be made to the preferred embodiments of the invention without departing substantially from the spirit and principles of the invention. All such modifications and variations are intended to be included herein within the scope of the present invention, as defined by the following claims.

I claim:

1. A method of assembling a pliers actuation assembly group designed and configured to be coupled to a pliers head to form pliers in such a way that a stroke of die halves of the pliers head can be brought about by means of manual actuation of the pliers actuation assembly group, the pliers actuation assembly group comprising
two hand levers, at least one of the hand levers having a first hand lever plate and a second hand lever plate which are rigidly connected to one another,
a pivot bolt via which the hand levers are pivotably connected to one another,
a mounting element,
wherein the mounting element has a first and second shoulder and a first and second protrusion protruding from the first and second shoulder,
the method comprising the following method steps:
a) joining the mounting element in a joining direction with the first hand lever plate, whereby the first protrusion of the mounting element enters into a first accommodation of the first hand lever plate and the first shoulder of the mounting element comes into contact with the first hand lever plate in the joining direction or is arranged adjacent thereto, and
b) joining the second hand lever plate in the joining direction onto the mounting element, whereby the second protrusion of the mounting element enters into a second accommodation of the second hand lever plate and the second shoulder of the mounting element comes into contact with the second hand lever plate or is arranged adjacent thereto, and
c) fixing a relative position of the first and second hand lever plate, whereby the first and second shoulder of the mounting element are trapped between the first and second hand lever plate so that the mounting element is secured against disassembly from the first and second accommodation of the first and second hand lever plate.

2. The method of claim 1, wherein said mounting element is embodied as
a) a pulling bar which is pivotally linked to the first and/or second hand lever plate and arranged and configured for coupling the pliers actuation assembly group to a pliers head or
b) a locking pawl being part of a forced locking mechanism which provides that a partially closed position of the hand levers reached within the stroke is secured in a ratchet-like manner and an opening movement of the hand levers is only possible at an end of the stroke, or
c) a spring being part of a forced locking mechanism which provides that a partially closed position of the hand levers reached within the stroke is secured in a ratchet-like manner and an opening movement of the hand levers is only possible at an end of the stroke, a spring base of the spring being supported on the first and/or second hand lever plate and the spring biasing a locking pawl of the forced locking mechanism.

3. The method of claim 2, wherein the mounting element integrally forms the first and second protrusion and the first and second shoulder.

4. The method of claim 2, wherein the assembly is at least partially automated.

5. The method of claim 3, wherein the assembly is at least partially automated.

6. A pliers actuation assembly group designed and configured to be coupled to a pliers head to form pliers in such a way that a stroke of die halves of the pliers head can be brought about by means of manual actuation of the pliers actuation assembly group, the pliers actuation assembly group comprising
a) two hand levers, at least one of the hand levers having a first hand lever plate and a second hand lever plate which are rigidly connected to one another,
b) a pivot bolt via which the hand levers are pivotably connected to one another,
c) a mounting element,
d) the mounting element having a first and second shoulder and a first and second protrusion protruding from the first and second shoulder,
e) the mounting element been joined with the first hand lever plate in a joining direction so that the first protrusion of the mounting element extends into a first accommodation of the first hand lever plate and the first shoulder of the mounting element contacts the first hand lever plate in the joining direction or is arranged adjacent thereto,
f) the second hand lever plate being joined in the joining direction onto the mounting element so that the second protrusion of the mounting element extends into a second accommodation of the second hand lever plate and the second shoulder of the mounting element contacts the second hand lever plate or is arranged adjacent thereto,
g) a relative position of the first and second hand lever plate being fixed to each other,
h) the first and second shoulder of the mounting element being trapped between the first and second hand lever plate so that the mounting element is secured against disassembly from the first and second accommodation of the first and second hand lever plate.

7. The pliers actuation assembly group of claim 6, wherein said mounting element is embodied as
a) a pulling bar which is pivotally linked to the first and/or second hand lever plate and arranged and configured for coupling the pliers actuation assembly group to a pliers head or
b) a locking pawl being part of a forced locking mechanism which provides that a partially closed position of the hand levers reached within the stroke is secured in a ratchet-like manner and an opening movement of the hand levers is only possible at an end of the stroke or
c) a spring being part of a forced locking mechanism which provides that a partially closed position of the hand levers reached within the stroke is secured in a ratchet-like manner and an opening movement of the hand levers is only possible at an end of the stroke, a spring base of the spring being supported on the first and/or second hand lever plate and the spring biasing a locking pawl of the forced locking mechanism.

8. The pliers actuation assembly group of claim 7, wherein the mounting element is formed integrally with the first and second shoulder and the first and second protrusion.

9. The pliers actuation assembly group of claim 7, wherein the first and second accommodation of the first and second hand lever plate wherein the first and second protrusion are accommodated and supported each have a cross section with a closed edge.

10. The pliers actuation assembly group of claim 8, wherein the first and second accommodation of the first and second hand lever plate wherein the first and second protrusion are accommodated and supported each have a cross section with a closed edge.

11. The pliers actuation assembly group of claim 6, wherein the mounting element is embodied as a locking pawl being part of a forced locking mechanism which provides that a partially closed position of the hand levers reached within the stroke is secured in a ratchet-like manner and an opening movement of the hand levers is only possible at an end of the stroke, the locking pawl being a bent sheet metal part, the bent sheet metal part integrally forming
the first and second shoulder,
the first and second protrusion,
an engaging part for a toothing of the forced locking mechanism and
an actuating part for a spring of the forced locking mechanism.

12. The pliers actuation assembly group of claim 6, wherein the mounting element is embodied as a spring being part of a forced locking mechanism which provides that a partially closed position of the hand levers reached within the stroke is secured in a ratchet-like manner and an opening movement of the hand levers is only possible at an end of the stroke, a spring base of the spring being supported on the first and/or second hand lever plate and the spring biasing a locking pawl of the forced locking mechanism, the spring being a T-shaped metal sheet spring,
a vertical leg of the T forming a leaf spring,
horizontal legs of the T forming the first and second protrusion and
transitions from the vertical leg to the horizontal legs of the T forming the first and second shoulder.

13. The pliers actuation assembly group of claim 6, wherein
a) said mounting element is embodied as a pulling bar which is pivotally linked to the first and/or second hand lever plate and arranged and configured for coupling the pliers actuation assembly group to a pliers head,
b) a spring is a part of the forced locking mechanism, a spring base of the spring being supported on the first and/or second hand lever plate and the spring biasing a locking pawl of the forced locking mechanism,
c) the spring of the forced locking mechanism is a leg torsion spring, a coil or spiral spring or a circular spring having two legs, wherein
ca) one leg has an end-sided angled section which is oriented parallel to a bending axis of the leg spring, coil or spiral spring or circular spring and forms a third protrusion which is received in a third accommodation of the first or second hand lever plate and
cb) the other leg biases the locking pawl of the forced locking mechanism.

14. The pliers actuation assembly group of claim 6, wherein
a) said mounting element is embodied as a locking pawl being part of a forced locking mechanism which provides that a partially closed position of the hand levers reached within the stroke is secured in a ratchet-like manner and an opening movement of the hand levers is only possible at an end of the stroke,
b) a spring is a part of the forced locking mechanism, a spring base of the spring being supported on the first and/or second hand lever plate and the spring biasing the locking pawl of the forced locking mechanism,
c) the spring of the forced locking mechanism is a leg torsion spring, a coil or spiral spring or a circular spring having two legs, wherein
ca) one leg has an end-sided angled section which is oriented parallel to a bending axis of the leg spring, coil or spiral spring or circular spring and forms a third protrusion which is received in a third accommodation of the first or second hand lever plate and
cb) the other leg biases the locking pawl of the forced locking mechanism.

15. The pliers actuation assembly group of claim 13, wherein the other leg has an end-sided angled section which is oriented parallel to a bending axis of the leg spring, coil or spiral spring or circular spring and forms a fourth protrusion that engages a fourth accommodation of the locking pawl.

16. The pliers actuation assembly group of claim 14, wherein the other leg has an end-sided angled section which is oriented parallel to a bending axis of the leg spring, coil or spiral spring or circular spring and forms a fourth protrusion that engages a fourth accommodation of the locking pawl.

17. The pliers actuation assembly group of claim 11, wherein the locking pawl
a) has a securing position in which it can slide in a ratchet-like manner along a toothing of the forced locking mechanism during a closing movement of the hand levers, but blocks an opening movement of the hand levers,
b) has a release position in which it can slide in a ratchet-like manner along the toothing of the forced locking mechanism during an opening movement of the hand levers, wherein the spring is coupled to the locking pawl in a way such that a biasing of the spring is at a minimum in a position between the securing position and the release position.
